(19) United States
(12) Patent Application Publication
(10) Pub. No.: US 2024/0170753 A1
(43) Pub. Date: May 23, 2024

(54) METHOD OF FORMING A REUSABLE BATTERY ASSEMBLY

(71) Applicant: ADVANCED BATTERY CONCEPTS, LLC, Clare, MI (US)

(72) Inventors: Edward O. Shaffer, II, Farwell, MI (US); Shaun Bruno, Corunna, MI (US); Michael Harmon, Clare, MI (US); Reed A. Shick, Midland, MI (US)

(21) Appl. No.: 18/547,097

(22) PCT Filed: Feb. 22, 2022
(86) PCT No.: PCT/US2022/017357

§ 371 Date: Aug. 18, 2023

Related U.S. Application Data
(60) Provisional application No. 63/151,459, filed on Feb. 19, 2021.
(60) Provisional application No. 63/256,253, filed on Oct. 15, 2021.

(51) Int. Cl. H01M 10/54; H01M 4/02; H01M 4/04; H01M 4/56; H01M 4/66; H01M 10/04; H01M 10/42; H01M 50/691

(52) U.S. Cl. CPC H01M 10/54; H01M 4/0469; H01M 4/56; H01M 4/661; H01M 10/0468; H01M 10/4285; H01M 50/691; H01M 2004/028; H01M 10/0418; H01M 10/044

(57) ABSTRACT

A method for reusing components of a battery (used battery assembly), such as a bipolar battery, to form another battery (reused battery assembly). The method may find use in allowing for a battery to be used, disassembled, recycled or reprocessed, assembled, and reused all within a single facility. A method for preparing a reused battery assembly including: a) disassembling a used battery assembly; b) salvaging one or more used components from the used battery assembly to provide for one or more reused components; and c) assembling a reused battery assembly with the one or more reused components.

### FIELD OF INVENTION

The present disclosure relates to a method for reusing most or all components of a bipolar battery assembly. The disclosure may find use in avoiding greenhouse gas generation associated with battery use and reuse and may provide a more environmentally friendly means of extending a battery's lifetime. The present disclosure may find particular use in providing a closed loop energy storage facility, in which bipolar battery assemblies are able to be assembled, charged, discharged, disassembled, reassembled, recharged, and used repetitively.

### BACKGROUND

Bipolar battery assemblies are typically formed as stacks of adjacent electrochemical cells. These batteries comprise a number of stacked electrode plates, with bipolar plates between and monopolar plates at opposing ends. The electrode plates are arranged in a stack such that anodic mass of one plate faces cathodic mass of the next plate. In most assemblies, there are battery separators located between the adjacent plates, which allow an electrolyte to flow from the cathodic mass to the anodic mass. Disposed in the space between the plates is an electrolyte, which is a material that allows electrons and ions to flow between the anodic and cathodic masses. The adjacent surfaces of the bipolar plates with the separator and the electrolyte disposed between the plates form an electrochemical cell where electrons and ions are exchanged between the anodic material and the cathodic material.

Bipolar battery assemblies typically have a limited cycle life. The cycle life may be impacted by deep cycling causing additional strain, corrosion of electrodes, depletion of active mass, deformation of the battery plates due to filling and operational conditions, and the like. Commonly known solutions to increase the cycle life of a battery assembly tend to go against the need for smaller and lighter weight assemblies that are able to exhibit longer lifespans. Although the technology is battery chemistry agnostic, bipolar lead acid batteries will be used for most discussion examples. For example, thicker battery plates and current collectors may be corroded away slower but yield larger and heavier assemblies. As another example, sealed lead acid (SLA) and valve regulated lead acid (VRLA) batteries are prevented from being charged to their full potential to avoid internal gas generation and resulting expansion and deformation of the battery plates. And as another example, absorbent glass mat (AGM) batteries utilize absorbent glass mats between battery plates to provide for lower self-discharge and allow for longer term storage before recharging. However, AGM batteries are acid starved and typically have higher oxygen crossover and shorter cycle life. Thus, while a number of solutions have been created to extend the lifespan of bipolar battery assemblies, there is still the challenge that there is still a limited service life before the battery assembly is no longer able to charge and/or discharge.

A typical method of disposing of bipolar battery assemblies after they have reached the end of their service life is ground up and recycling. Recycling can be time-consuming and complex, with deactivation/discharging of the battery, disassembly of the battery, mechanical processes to obtain individual subcomponents, and extraction and stripping processes to break down and obtain materials of the assembly in a recyclable form. After recycling, the extracted materials may then be reformed into components of a battery assembly or may even be used in other industries. While this may be seen as an environmentally friendly alternative as opposed to disposing, the recycling process still requires a significant amount of energy for recovering and recycling materials, produces a significant carbon footprint, can be costly, and requires many of the same processes for reusing the materials as using new materials.

Thus, what is needed is a method in which bipolar battery assembly components are not just recycled, but actually reused for the same or a subsequent bipolar battery assembly. What is needed is a method in which bipolar battery assemblies that have reached the end of their service life, can be disassembled and remanufactured into another bipolar battery assembly at the same location to provide for a closed loop energy storage facility.

### SUMMARY

The present teachings relate to a method for preparing a reused battery assembly comprising: a) disassembling a used battery assembly; b) salvaging used components from the used battery assembly to provide for reused components; and c) assembling a reused battery assembly with the reused components.

The method may include one or more of the following steps and/or features in any combination: the method may be performed entirely at a single facility; disassembling may include removing an electrolyte, removing one or more outer seals, removing one or more posts, separating one or more electrode plates, breaking down one or more electrode plates, removing one or more separators, removing one or more cell seals, removing one or more channel seals, removing spent active mass, the like, or a combination thereof; salvaging one or more used components may include reprocessing one or more spent active masses to provide for one or more active masses; removing, cleaning, and/or repairing one or more conductive components of an electrode plate; or a combination thereof; assembling a reused battery may include forming one or more reused electrode plates, forming an electrode plate stack, applying an outer seal, incorporating an electrolyte, charging the reused battery assembly, or a combination thereof; liquid electrolyte may be drained via one or more valves of the used battery assembly; one or more outer seals may be removed via force, cutting, applying heat, applying one or more solvents, applying vibration, the like, or a combination thereof; the one or more outer seals may have a different color as an exterior surface of one or more electrode plates; upon removal of the one or more outer seals a color of the exterior surface of the electrode plates may be exposed; removing one or more posts may remove a compressive force holding a stack of electrode plates together; removing the one or more posts may include removing the posts from one or more channels which extend through spent active mass of the used battery assembly; the one or more posts may be removed via mechanical force, cutting, heat, solvents, vibration, the like, or a combination thereof; removing the one or more posts may include unthreading one or more overlapping portions from one or more shafts; removing the one or more posts may include breaking one or more overlapping portions from one or more shafts; the one or more posts may be a different color than one or more substrates, separators, active mass, or a combination thereof; removal of one or more posts from one or more channels, an interior color of the one or more channels may be exposed; breaking down one or more electrode plates may include removing one or more separators, spent active mass, cell seals, channel seals, conductive components, the like, or a combination thereof; salvaging may include reprocessing one or more spent active masses to create one or more active masses; salvaging may include keeping a positive active mass separate from a negative active mass during removal and reprocessing; the one or more spent active masses may include lead sulfate, lead oxide, lead, nickel cadmium, nickel metal hydride, lithium ion, lithium cobalt oxide, lithium iron phosphate, lithium nickel manganese cobalt oxide, lithium manganese oxide, lithium titanate, iron air, sodium ion, vanadium or a combination thereof; the one or more spent active masses may be reconstituted into paste form; the one or more spent active masses may undergo one or more hydrometallurgical processes, pyrometallurgical processes, electrowinning, the like, or a combination thereof; wherein the one or more spent active masses may undergo leaching, desulfurization, calcification, thermal degradation, electrolytic processing, the like, or a combination thereof; one or more conductive components may include one or more current collectors, conductive materials, current conduits, terminals, the like, or a combination thereof; the one or more conductive components may be cleaned to have corrosion removed; corrosion may be removed via an aqueous solution, flushing with water, laser, sanding, other mechanical force, the like, or any combination thereof; one or more conductive components may be repaired and/or removed and replaced on a substrate of the electrode plate; forming the one or more reused electrode plates may include assembling one or more reused components of an electrode plate; the one or more reused electrode plates may be assembled using one or more reused substrates, reused cell seals, reused channel seals, reprocessed active mass, the like, or a combination thereof; the one or more reused electrode plates may include a reused separator located on the reprocessed active mass; assembling may include forming an electrode plate stack; forming the electrode plate stack may include aligning and stacking a plurality of electrode plates to form one or more electrochemical cells therebetween; one or more frames, inserts, or both of one electrode plate may be aligned and interlocked with one or more other frames, inserts, or both of an adjacent electrode plate; one or more channels may be formed by aligning and interlocking inserts of a plurality of electrode plates; assembling may include compressing an electrode plate stack; compressing may include locating and/or forming one or more posts within one or more channels; the one or more posts may be reused posts, reprocessed posts, or both; assembling may include applying one or more outer seals about an electrode plate stack; assembling may include incorporating an electrolyte into a plurality of electrochemical cells of the electrode plate stack to form the reused battery assembly; and the electrolyte may be a liquid electrolyte.

The present teachings provide for an electrode plate having: a) a substrate with one or more active masses disposed on one or more surfaces; b) a frame about the one or more active masses, wherein the frame is integral with or affixed to the substrate; and c) one or more sealing members integral with and/or affixed to an inward-facing surface of the frame.

The present teachings provide a means of salvaging and reusing used components of a battery assembly. The method may be particularly useful in reusing some or all components once a battery assembly reaches the end of its service life. The method may prove useful for providing a closed loop system in which batteries may be used, reach the end of service life, salvaged, then reutilized to form reused bipolar battery assemblies within the same facility. The present teachings may be particularly useful for use in electrical storage facilities that may cooperate with alternative energy sources. The teachings of the present disclosure may eliminate battery components from being disposed into landfills and recycled through processes which still have a significant carbon footprint.

### BRIEF DESCRIPTION OF DRAWINGS

FIG. 1 illustrates a partially exploded stack of electrode plates of a battery assembly.

FIG. 2 illustrates a partially exploded stack of electrode plates of a battery assembly.

FIG. 3 illustrates a perspective view of an electrode plate.

FIG. 4 illustrates a cross-section view of battery assembly.

FIG. 5 illustrates stacking of electrode plates of a battery assembly.

FIG. 6 illustrates a method of preparing a reused battery assembly.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Method of Preparing Reused Battery Assembly

The present disclosure may relate to a method of preparing a reused battery assembly. The method may be particularly useful in extracting, salvaging, and/or reprocessing components of a used battery assembly and reusing to form a reused battery assembly. The method may be quite advantageous in that in can allow for a closed loop energy storage facility. This may mean that the entire method may be able to be performed entirely within a single facility. Closed loop may mean that a battery assembly can be delivered to and/or built, charged and discharged repetitively for its initial service life, disassembled and salvaged, then assembled and charged again for a new service life, all within the same facility. A closed loop energy storage facility may prove useful for cooperating with, storing, and discharging energy from alternative energy sources, such as wind and solar. The method may include disassembling a used battery assembly, salvaging used components, assembling a reused battery assembly, or a combination thereof. Disassembling may allow for extraction and cleaning of components for reusing, recycling, reprocessing, and the like. Disassembling may yield one or more components as described hereinafter under the battery assembly. Disassembling may yield used components of the battery assembly which are then able to be cleaned and/or repaired and then reused in a reused battery assembly. Disassembling may include removing one or more weak sections from a used battery assembly. Disassembling may include disassembling one or more weak sections of a used battery assembly. Disassembling may include removing an electrolyte, removing one or more outer seals, removing one or more posts, separating one or more electrode plates, breaking down one or more electrode plates, removing one or more separators, removing one or more cell seals and/or channel seals, removing spent active mass, removing one or more current collectors and/or conductive materials, the like, or a combination thereof. The method may include salvaging one or more used components of a battery assembly. Salvaging one or more used components may include reprocessing one or more spent active masses; removing, cleaning, and/or repairing one or more conductive components; or a combination thereof. The method may include assembling a reused battery assembly with reused components. Assembling may include rebuilding one or more weak sections. Assembling may include assembling one or more reused components to form a reused battery assembly. Assembling may include assembling one or more rebuilt sections (i.e., previously weak sections) to one or more good sections of a used battery assembly to form a reused battery assembly. Assembling may include assembling one or more reused components where no good sections were identified or reused (e.g., used battery was wholly disassembled). Assembling may include forming one or more reused electrode plates, forming an electrode plate stack, applying an outer seal, incorporating an electrolyte, charging the battery assembly, the like, or a combination thereof.

The method may include identifying portions of a battery assembly (i.e., used battery assembly) for disassembling. The portion of the battery assembly may be an individual cell, a battery or several batteries within the battery assembly. Identifying portions for disassembling may aid in identifying only portions of a battery assembly which may need to be repaired, replaced, and/or salvaged without needing to disassemble the battery assembly in its entirety. Identifying one or more portions may include testing a used battery assembly. Testing may include testing the entire battery assembly, one or more battery units, one or more electrochemical cells, the like, or a combination thereof. Testing may identify one or more weak sections of a used battery assembly. Testing may include determining one or more performance values of the battery assembly, one or more battery units, one or more electrochemical cells, or a combination thereof. Testing may include monitoring and/or determining charge, discharge, and/or both of one or more battery units part of the battery assembly. Testing may be done with one or more testing devices. Wherein the one or more testing devices may determine one or more performance values of the one or more electrochemical cells, battery units, and/or battery assembly. One or more testing devices may include a voltmeter, ammeter, AC impedance meter, DC impedance meter, ohmmeter, capacitance meter, multimeter, battery hydrometer, the like, or a combination thereof. Testing may be manual, partially automated, and/or completely automated. Testing may include placing a battery assembly and/or unit in a testing station. A testing station may include one or more testing devices. One or more testing devices may be configured to automatically test all and/or a portion of a battery assembly. For example, one or more robotic arms and/or balancers may include one or more probes and/or leads of a testing device, may be automated to automatically connect to one or more terminals and/or cell interiors of a battery assembly, and may determine one or more performance conditions of the battery assembly. Testing may monitor the overall battery assembly to see if it is performing as expected (e.g., at or above one or more performance thresholds). Testing may determine if the battery assembly, one or more battery units, one or more electrochemical cells, or a combination thereof are performing above, at, or below one or more performance thresholds. For example, a multimeter may be affixed to the positive and negative terminals to determine an overall voltage of the battery assembly. If the battery assembly is performing below a performance threshold for the battery as a whole, each battery unit and/or electrochemical cell may then be tested. A performance value may be the actual performance of the battery assembly which is measured and then compared to the performance threshold. For example, each battery unit may be tested by affixing one lead of the meter to the positive terminal of the battery unit and the other lead of the meter to the negative terminal of the battery unit or within an interior of the cell and in contact with the electrolyte. As an example, with lead acid electrochemistry, if each cell is capable of storing approximately 2V, then each cell should account for about 2V of the battery assembly and/or battery units overall voltage if in good working order. A cell which contributes less than 2V may be identified as a cell performing under an individual cell performance threshold. As another example, electrolyte from each cell may be drawn into a hydrometer. The specific gravity of the electrolyte determined by the hydrometer may then be correlated to a percentage charge the cell is storing. Access for one or more testing leads, probes, and/or the like into one or more electrochemical cells may be via one or more vents, channels, and/or openings. One or more performance thresholds for charging, discharging, or both may be established. One or more performance thresholds, performance values, or both may include capacity, open-circuit voltage, resistance, specific gravity, the like, or a combination thereof. One or more performance thresholds may include the voltage stored in each cell within the battery assembly when the battery assembly has reached a full charge. One or more performance thresholds may be a cell, battery unit, and/or battery assembly being charged 70% or greater, 75% or greater, or even 80% or greater. One or more performance thresholds may be a cell, battery unit, and/or battery assembly being charged 95% or less, 90% or less, or even 85% or less. For example, if a performance threshold is holding 80% of a charge or higher, and via testing, a cell measures at 75% charge, that cell may be determined as performing below the 80% performance threshold. If during testing one or more performance values during charging and/or discharging falls below one or more performance thresholds, the battery unit and/or cell may be identified as a weak section of the used battery assembly.

The method may include isolating one or more sections. The one or more sections may be one or more weak sections. One or more weak sections may be isolated prior to initiating disassembly. Isolating weak sections may refer to those of a used battery assembly. Isolating the weak sections may allow for the one or more weak sections to be disassembled without having to disassemble the entire battery assembly. Isolating may mean mechanically and/or electrically isolating one or more weak sections from one or more good sections. A good section may mean one or more electrochemical cells and/or battery units performing at or above their performance threshold. Isolating may include clamping one or more good sections, weak sections, or both. Isolating may include blocking a fluid connection between one or more cells and one or more other cells. For example, one or more valves, openings, and/or channels connecting the one or more cells to one or more other cells may be temporarily blocked. Temporarily blocking a fluid connection may allow for one or more weak sections to be removed without draining all of the electrolyte from the entire battery assembly. One or more steps of disassembling, assembling, or both may only be performed on one or more weak sections, the entire battery assembly, or both. One or more weak sections may be disassembled while a remainder of the used battery assembly remains intact.

The method may include applying a clamping device. A clamping device may be applied to a battery assembly prior to disassembly, during assembly, or both. A clamping device may aid in holding the battery assembly together in a compressed fashion, retaining one or more electrode plates aligned with one another, maintaining one or more seals, retaining one or more electrochemical cells together, or any combination thereof. A clamping device may be applied such that it compresses a first and second end of the battery assembly, two or more electrode plates of battery units not identified as weak section (e.g., do not need to be disassembled), and/or the like. One or more clamping devices may be applied to a battery assembly. For example, a first clamping device may clamp a stack of electrode plates adjacent to one side of a weak section while a second clamping device may clamp a stack of electrode plates adjacent to another side of the weak section. This allows for the weak section to be removed while the electrode plates of the well performing sections are retained together as one or more stacks of electrode plates. A clamping device may include any suitable device for retaining a plurality of electrode plates stacked together and applying a compression force. A clamping device may be an external clamping device. A clamping device may include a C-Clamp, hand clamp, quick action clamp, edge clamp, bench clamp, mechanical clamp, spring clamp, scissor clamp, F-clamp, hydraulic clamp, table clamp, pneumatic clamp, beam clamp, the like, or any combination thereof.

Disassembling may include removing an electrolyte from within the battery assembly. Removing the electrolyte may allow for one or more outer seals and/or cell seals to then be removed. Removing the electrolyte may include removing electrolyte from the entirety of a battery assembly, one or more battery units, and/or one or more electrochemical cells. Removing electrolyte may involve draining and/or drawing electrolyte via one or more valves, openings, and/or channels. A vacuum may be applied via one or more valves, openings, and/or channels. A vacuum may draw liquid electrolyte from one or more electrochemical cells to the exterior of the battery assembly. To draw a vacuum from the battery assembly, the battery assembly or stack of electrode plates may be placed within a vacuum chamber, affixed to a vacuum pump, or both. One or more channels, openings, and/or vents may aid in drawing a vacuum. One or more channels may be in fluid communication with the space within one or more electrochemical cells. The electrolyte may be stored within this space. One or more pumps may be in fluid communication with one or more channels such as to draw an internal vacuum. Drawing a vacuum may include an evacuation such that the internal pressure within the electrode plate stack is below atmospheric pressure, draws the electrolyte out of the electrochemical cell(s), or both. One or more reinforcement structures, end plates, monopolar plates, frames, inserts, posts, and/or the like may provide reinforcement against inward buckling while a vacuum is drawn and the electrolyte is removed. The electrolyte may be stored in any container suitable for being in contact with the highly acidic material.

Disassembling may include removing one or more outer seals. Removing an outer seal may allow for a stack of electrode plates to be separated from one another, allow access into an interior of the battery assembly, or both. Removing an outer seal may include removing a case, removing a membrane, breaking an edge seal, the like, or a combination thereof. Removal may include application of force, cutting, application of heat, application of one or more solvents, application of vibration, or any combination thereof. Application of force may include physical removal of a stack of electrode plates from the interior of a case (e.g., pulling, peeling), pulling apart one or more frames from one or more other frames, or both. Cutting may include cutting via one or more mechanical blades, lasers, the like, or a combination thereof. Cutting may be about a periphery of one or more electrode plates and/or separators, between an outer seal and a stack of electrode plates, or both. For example, a joint between adjacent frames of electrode plates may be cut. Application of heat may include applying sufficient heat such that a thermoplastic material of an outer seal and/or electrode plate sufficiently softens and melts and is able to be separated. Application of one or more solvents may allow for a thermoplastic of an outer seal and/or electrode plate to soften and be removed with application of pressure. One or more solvents may include one or more solvents compatible with one or more thermoplastics. One or more solvents may include methyl ethyl ketone, methyl isobutyl ketone, methylene chloride, ethylene dichloride, vinyl trichloride, acetone, toluene, xylene, benzene, the like, or any combination thereof. The one or more outer seals may have a different color as an exterior surface of one or more electrode plates. An exterior surface may refer to the frames, substrates, or both. A different color may allow for an individual person and/or image sensor to visually verify that the entirety of the outer seal has been removed from an exterior of a stack of electrode plates.

Disassembling may include removing one or more compressive forces from one or more electrode plates of a stack of electrode plates. Removing one or more compressive forces may allow for one or more electrode plates to be removed from a stack of electrode plates. Removing one or more compressive forces may include removing one or more posts. Removing one or more posts may remove one or more compressive forces retaining a plurality of electrode plate stacked together. One or more posts may be removed by removing one or more overlapping portions. Removal of an overlapping portion may include unthreading, pulling, cutting, applying solvent, applying heat, applying vibration, the like, or any combination thereof. Removal of an overlapping portion may involve removal of the overlapping portion from one or more shafts, channels, exterior surfaces (e.g., end plate outer surfaces), the like, or a combination thereof. Removal of an overlapping portion may expose one or more shafts. After removal of an overlapping portion, one or more shafts of a post may be removed. The shaft may be removed from one or more channels. A shaft may be removed by unthreading, pulling, cutting, applying solvent, applying heat, applying vibration, or any combination thereof. Methods of removing a post may be similar as those disclosed for removing an outer seal. One or more portions of a post may be a different color than one or more substrates, separators, inserts, active mass, interior surface of one or more openings, or a combination thereof. Upon removal of one or more posts from one or more channels, an interior color of the one or more channels is exposed. A different color of the post(s) may allow for an individual person and/or an image sensor to visually verify that the entirety of the post has been removed from a channel.

Disassembling may include separating one or more electrode plates from one or more other electrode plates. The electrode plates may be stacked and interlocked via one or more frames, inserts, sealing members, or a combination thereof. Separating one or more electrode plates may include applying an opposing force to one or more adjacent electrode plates. Separation may be manual and/or mechanical. Manual may refer to an individual person using their hands and/or one or more hand tools to separate the one or more electrode plates. Mechanical may refer to one or more automated devices applying a force to separate the one more electrode plates. Separating electrode plates may including disengaging one or more frames, inserts, sealing members, or a combination thereof from one or more other frames, inserts, sealing members, or a combination thereof. Separating electrode plates may yield one or more electrode plates having spent active mass located on one or both sides of a substrate, one or more separators adhered to the active mass, a cell seal affixed about a periphery of a substrate and/or frame, or any combination thereof.

Disassembling may include breaking down one or more electrode plates. Breaking down an electrode plate may allow for one or more components to be salvaged, such as by cleaning, repairing, reprocessing, and the like. Breaking down an electrode plate may include removing one or more separators, transfer sheets, cell seals, channel seals, active masses (e.g., spent active mass), current collectors, current conduits, conductive components, and the like.

Disassembling may include separating one or more separators and/or transfer sheets from one or more electrode plates. This separation may be part of the breakdown process. One or more separators and/or transfer sheets may be removed from one or more active masses, another separator and/or transfer sheet, or both. One or more separators and/or transfer sheets may be peeled away from one or more active masses, separators and/or transfer sheets. One or more separators and/or transfer sheets may be cleaned of active mass, recycled, disposed, or any combination thereof. One or more active masses may be exposed after removal of one or more separators, transfer sheets, separation of an electrode plate from a stack, or both.

Disassembling may include removing one or more active masses from one or more substrates and/or separators. Removing the active mass (spent active mass) may also be considered part of the salvaging. This removal may be part of the breakdown process. One or more active masses may be removed via physical force, dissolution, or both. Physical force may include scraping, vacuum removal, and/or the like. Dissolution may include use of a dissolution solvent. The dissolution solvent may be applied to the one or more active masses while still one the one or more substrates and/or separators. The dissolution solvent may include methane sulfonic acid, acetic acid, or sodium hydroxide or any combination. The one or more active masses may be spent active mass(es) prior to and/or after application of the dissolution solvent. After dissolution, one or more spent active masses may be precipitated. As an alternative, removal of one or more spent active masses may be free of dissolution. One or more spent active masses may be collected for reprocessing and reuse as opposed to being disposed. Upon removing of one or more spent active masses, one or more substrates, current collectors, and/or conductive materials may be exposed. The one or more current collectors and/or conductive materials may be found to be significantly degraded through corrosion from previous charging and discharging of the battery assembly.

Disassembling may include removing one or more cell seals, channel seals, or both. Removal of the one or more seals may allow for reuse of the seals. This removal may be part of the breakdown process. After separating one or more electrode plates from one or more other electrode plates, one or more cell seals, channel seals, or both may be exposed. The one or more cell seals, channel seals, or both may be removed from one or more frames, substrates, inserts, openings, or any combination thereof. The one or more cell seals and/or channel seals may be removed via force, heat, solvents, the like, or any combination thereof. The one or more cell seals, channel seals, or both may be removed using one or more processes suitable for removing one or more outer seals, overlapping portions, shafts, or a combination thereof. The one or more cell seals and/or channel seals may be cleaned of one or more active masses, electrolyte residue, or both. By removing residual active mass, electrolyte residue, or both, the one or more seals may be suitable for reuse and creating a mechanical seal again.

Salvaging may include reprocessing one or more spent active masses. Reprocessing may allow for the one or more spent active masses to create one or more active masses, be reused as active mass in a reused battery assembly, avoid recycling and/or disposing of the spent active mass, or both. Reprocessing may include segregating, reconstituting, recycling, the like, or a combination thereof. During and after removal from a substrate, the one or more active masses may be kept separate based on their polarity. Positive active mass (PAM) may be segregated from, kept segregated from, and/or combined with negative active mass (NAM). Spent active mass may include lead sulfate, lead oxide, lead, lead dioxide, the like, or a combination thereof. Once removed from the substrate, the spent active mass may be reconstituted into active mass. The spent active mass may be reconstituted into a paste form. The spent active mass may be converted into a slurry. Reconstituting an active mass may include reducing the active mass to lead. Reconstituting an active mass may include forming a lead into a lead sulfate, a lead oxide, lead dioxide, the like or a combination thereof. To be reconstituted, the spent active mass may be desulfurized. To be reconstituted, the spent active mass may have one or more binders added therein. As another option, the one or more spent active masses may be recycled for use to prepare a new active mass. Reprocessing may include one or more hydrometallurgical processes, pyrometallurgical processes, or both. Hydrometallurgical processing may be advantageous in reducing emission of lead and/or sulfur dioxide dust and reducing energy consumption. Recycling may include leaching, electrowinning, desulfurization, calcification, thermal degradation, electrolytic processing, the like, or any combination thereof. The spent active mass may be leached with one or more leaching reagents. Leaching reagents may include sodium citrate, acetic acid, hydrogen peroxide, halide, the like, or a combination thereof. By reacting with one or more leaching reagents, lead, lead oxide, lead sulfate, or a combination thereof may be separated for reuse. Alkaline solution, such as sodium hydroxide, may dissolve the lead sulfate for removal and then via calcination, a lead oxide powder may be yielded. The spent active mass may be reprocessed and/or recycled into one or more usable active masses. Reprocessing one or more spent active masses may include charging the active mass. One or more suitable active masses may include those described in U.S. Pat. No. 10,141,598 and PCT Publication Nos. WO 2020/0091521 and WO 2020/0102677, incorporated herein by reference in their entirety.

Salvaging may include removing, cleaning, and/or repairing one or more conductive components. One or more conductive components may include one or more current collectors, conductive materials, current conduits, and/or terminals. The one or more conductive components may have corrosion removed by being cleaned. Corrosion may be removed via an aqueous solution, flushing with water, laser, sanding, other mechanical force, chemical dissolution, the like, or any combination thereof. Upon removal of corrosion, the one or more conductive components may be evaluated for repair, removal, or both. As an alternative to or in addition to removing corrosion, one or more conductive components may be removed from a substrate. One or more current collectors may be removed from a surface of a substrate. The one or more current collectors have been located between the active mass and the substrate. One or more conductive materials may be removed from within one or more conductive openings of a substrate. One or more conductive materials may be removed via force, laser, heat, the like, or any combination thereof. One or more new conductive materials may be located within one or more conductive openings. One or more new conductive materials may be bonded and/or formed as part of one or more cleaned conductive materials. One or more new current collectors may be located on the substrate. One or more used current collectors may be repaired and then located on the substrate. Repairing may include adding additional current collector material to the used current collector.

The method may include assembling a reused battery assembly. Assembly of a reused battery assembly may provide for a battery assembly to be assembled using previously used, reprocessed, and/or recycled components of the same or a different battery assembly. A reused battery assembly may also include some new component(s) in combination with one or ore previously used, reprocessed, and/or recycled components.

Assembling may include forming one or more reused electrode plates. Forming one or more reused electrode plates may create one or more electrodes useful within the battery assembly with previously used electrode plates. Forming one or more reused electrode plates may include reconstructing one or more conductive materials, placement of one or more conductive materials, locating one or more active masses, applying one or more cell seals, applying one or more channel seals, the like, or a combination thereof. Forming one or more reused electrode plates may include using one or more reused components of a used electrode plate. Forming one or more reused electrode plates may include electroforming. Electroforming may include electroforming to a positive and/or negative active mass. One or more reused electrode plates may be assembled using one or more reused substrates, reused cell seals, reused channel seals, reprocessed active mass, the like, or a combination thereof

Forming one or more reused electrode plates may include reconstructing one or more conductive materials in one or more conductive openings, placement of one or more current collectors on a substrate, or both. Forming one or more reused electrode plates may be free of reconstructing one or more conductive materials and/or placement of one or more current collectors. For example, if the conductive material(s) and/or current collector(s) were found to only need to be cleaned to provide sufficient conductivity, surface area, and/or eliminate corrosion. One or more current collectors may include one or more durable conductors. A durable conductor may be any conductive material which avoids corrosion over time during operation of the battery assembly. A durable conductor may include a reusable foil. A reusable foil may comprise titanium.

Forming one or more reused electrode plates may include locating one or more active masses on one or both surfaces of a substrate. The one or more active masses may be made from one or more reprocessed and/or recycled active masses. The one or more active masses may be pasted onto the substrate. The one or more active masses may be applied as a wet paste. The one or more active masses may be cured, dried, remain as a wet paste, or any combination thereof. One or more reused electrode plates may include a reused separator located on a reprocessed and/or recycled active mass. The active mass may be applied on the separator prior to the active mass being located on the substrate, such that the separator is a transfer sheet. The separator may be applied on the active mass during stacking or the after application of the active mass onto the substrate. The one or more active masses may be applied via the application processes such as described in PCT Publication Nos. WO 2020/0091521 and WO 2020/0102677, incorporated herein by reference in their entirety.

Forming one or more reused electrode plates may include applying one or more cell seals, channel seals, or both. Before, during, or after application of one or more active masses, one or more cell seals, channel seals, or both may be applied. One or more cell seals may be applied to the substrate, frame, or both. One or more channel seals may be applied into one or more channel openings, about one or more channel openings, about one or more inserts, onto one or more inserts, or any combination thereof. The one or more cell seals, channel seals, or both may be reused cell seals, used channel seals, or both. The one or more cell seals, channel seals, or both may be retained by being located in one or more reciprocal grooves, with an adhesive, an interference fit, a form fit, gravity, the like, or a combination thereof.

Assembling may include forming an electrode plate stack. Forming an electrode plate stack may include aligning and stacking a plurality of electrode plates to form one or more electrochemical cells therebetween. One or more of the electrode plates of the electrode plate stack are used electrode plates while one or more other electrode plates are reused electrode plates, or all of the electrode plates are reused electrode plates. One or more separators may be located between each pair of electrode plates. The separators may be located simultaneously as during paste application, such as in the form of a transfer sheet. The separators may be located between cells during stacking. The separators may be reused separators. While aligning and stacking the plurality of electrode plates, the electrode plates and separators may be stacked in an alternating arrangement. One or more frames, inserts, sealing members, or a combination thereof of one or more electrode plates may align and/or interlock with one or more frames, inserts, sealing members of adjacent electrode plates and/or separators. A peripheral surface of the one or more frames may form part of an exterior surface of the electrode plate stack. Alignment and interlocking of a plurality of inserts may form one or more channels. Alignment and interlocking of a plurality of sealing members may form an internal, integrated cell seal. The method may include or be free of forming an integrated edge seal.

Assembling may include compressing an electrode plate stack. Compressing may allow for one or more seals to be maintained about one or more electrochemical cells, channels, or both; resist expansion during operation; resist buckling during filling with an electrolyte or evacuating; or any combination thereof. Compressing may include locating and/or forming one or more posts within one or more channels. Locating and/or forming one or more posts may include locating and/or forming one or more shafts within one or more channels. Compressing may include forming one or more overlapping portions of one or more posts such as to apply a compressive force to one or more end plates and/or monopolar plates. One or more overlapping portions may include threading, adhering, and/or the like one or more overlapping portions to one or more shafts, exterior surfaces of one or more end plates, or both. Compression may apply compressive force with one or more interlocking features. Interlocking feature(s) may include one or more frames, inserts, sealing members, the like, or a combination thereof. Compression may cause one or more sealing members to be compression fitted into one or more other sealing members to form a leakproof, integrated cell seal. The one or more posts may be reused posts. For example, one or more shafts may be inserted into the one or more channels and then secured in place by locating (e.g., threading) one or more heads thereon. As an alternative, one or more posts may be formed from reprocessed material from one or more used posts. For example, one or more used posts may have been made of a thermoplastic material which is melted during and/or after removal from a used battery assembly and then melt bonded into the one or more channels of the reused battery assembly.

Assembling the reused battery assembly may include applying an outer seal. Application of an outer seal may include or be free of forming an integrated seal, applying a membrane, inserting the electrode plate stack into a case, or a combination thereof.

Forming the electrode plate stack may include or be free of forming an integrated edge seal. Forming an integrated seal may be part of applying an outer seal. The integrated edge seal may be formed after stacking one or more reused electrode plates within one or more other electrode plates, separators, or both. The one or more integrated edge seals may be formed by mating, engaging, and/or bonding one or more frames, raised edges, exterior surfaces, projections, or a combination thereof with one or more other projections, frames, raised edges, exterior surfaces, and/or the like of one or more adjacent electrode plates, separators, or both. The integrated edge seal may be formed by any method suitable for bonding one electrode plate to an adjacent electrode plate and/or separator. Bonding may include using a separate adhesive, melt-bonding, or both. Bonding may be performed by any method of welding. Welding may include heat welding, solvent welding, the like, or any combination. Welding may be achieved by heated platens, heat generated by friction or vibration, ultrasonic, radiofrequency, induction loop wire, solvent, the like, or any combination thereof. The weld or other bonding method may provide for a continuous integrated seal about the periphery of one or more electrochemical cells. The weld or other bonding method may provide a mechanically strong seal about the periphery of the one or more electrochemical cells. Exemplary methods for forming an integrated edge seal are discussed in PCT Publication No.: WO 2020/243093, which is incorporated herein by reference in its entirety for all purposes.

Forming the electrode plate stack may include applying one or more membranes. Applying a membrane may be part of applying an outer seal. Applying the membrane may include or be free of preheating one or more exterior surfaces of an electrode plate stack. Preheating the exterior surface may help in maintaining the preheated temperature and flexibility of one or more membrane sheets during application, allow one or more membrane sheets to be form-fitted to the exterior surface, or both. Preheating may be useful if one or more membranes are not preheated prior to application. Heat may be applied directly or indirectly. The heat source may be distanced from the exterior surface. The temperature may be less than a softening point (glass transition temperature) and/or melting point of all of the components of the electrode plate stack. The temperature may be less than, equal to, or greater than a glass transition temperature of one or more membranes. The method may include or be free of preheating one or more membranes. Preheating the one or more membranes may soften the membrane(s) such that they are able to conform to the contours of an exterior surface, become form-fitted about the exterior surface, bond to one or more other membrane sheets, bond to one or more surfaces of an electrode plate stack, or any combination thereof. Preheating may prove even more advantageous if an exterior of the stack is not preheated prior to application of the membrane(s). Preheating may also be complementary to preheating an exterior of the stack prior to application of the membrane(s). Heat may be applied directly or indirectly. The heat source may be distanced from the one or more membrane(s). The temperature may be less than a melting point of the one or more membrane(s). The temperature may be at or greater than a softening point (glass transition temperature) of the one or more membrane(s). The heat source may preheat the one or more membrane(s) to a point at which they soften and are able to conform to the shape of the exterior surface. Preheating of one or more exterior surfaces, one or more membrane sheets, or both may be completed by one or more heat sources. One or more heat sources may function to apply heat. One or more heat sources may include one or more dry heat sources, moist heat sources, or both. One or more heat sources may include convection heaters, radiant heaters, or a combination of both. One or more exemplary heat sources may include one or more heat guns, infrared heaters, the like, or a combination thereof. The one or more membrane(s) may include preheated membrane(s), non-preheated (e.g., ambient) membrane(s), or both. Application of the membrane(s) may allow for the membrane(s) to form a membrane about the electrode plate stack. The one or more membrane(s) may be fitted about the one or more exterior surfaces. Fitted may mean form-fitted, bonded to, forming reciprocal contours, the like, or a combination thereof. Fitted may mean overmolded. Applying one or more membrane sheets may include drawing a vacuum within the electrode plate stack. A vacuum may allow for the one or more membrane sheets to be drawn inward toward the one or more exterior surfaces, to conform to one or more contours of one or more exterior surfaces, to have a form-fit to one or more exterior surfaces, or any combination thereof

Assembling may include incorporating an electrolyte. One or more electrochemical cells may be filled with electrolyte. All or a portion of the electrochemical cells of a battery assembly may be filled with an electrolyte. Filling a battery assembly may include flowing electrolyte through one or more ports into one or more vents and/or channels; one or more vents into one or more channels, one or more channels and/or vents into one or more openings, one or more channels, openings, and/or vents into one or more electrochemical cells. Filling may occur under a vacuum. Filling may include filling the battery assembly with one or more fluids while an interior of the battery assembly below atmospheric pressure. Below atmospheric pressure may be completed by evacuating. Below atmospheric pressure may be considered filling under a vacuum. Vacuum may include under a vacuum chamber, separate ports for simultaneously drawing a vacuum while filling with one or more fluids, utilizing a single port as a vacuum port (e.g., evacuation portion) and a fill port, the like, or any combination thereof. The battery assembly may be filled with electrolyte such as disclosed in PCT Publication WO 2013/062623 and U.S. Pat. No. 10,141,598, incorporated herein by reference in their entirety. Exemplary solutions for filling the battery assembly with electrolyte under a vacuum are disclosed in US Publication Nos. 2014/0349147 and 2017/0077545, incorporated herein by reference in their entirety.

Assembly may include charging the battery assembly. Providing a charge may allow for the battery assembly to be operational. The battery assembly may be attached to a power source such as to form a circuit including the electrochemical cells. The power source may be affixed to the terminals of the assembly. During charging, the electrochemical cells may flow electrons and ions in opposite directions as compared to discharging. The battery assembly may then be discharged to an external load and consideration in operation. The battery assembly may undergo multiple charges and discharges before reaching the end of its service life. At the end of service life, the battery assembly may then be disassembled and undergo the disassembly and assembly process again.

Battery Assembly

The battery assembly of the disclosure generally relates to a battery assembly and may find particular use as a bipolar battery assembly. The battery assembly may have any type of suitable chemistry. The chemistry of the battery assemblies may provide for one or more lead acid batteries, nickel metal hydride batteries, lithium ion batteries, lithium sulfur batteries, zinc batteries, aluminum batteries, sodium ion batteries, the like, or any combination thereof. In other words, the teachings disclosed herein may be applicable across a variety of battery chemistries. The battery assembly may be a new, used, and/or reused battery assembly. New may refer to all components which have never been utilized (e.g., discharged, part of a battery assembly in operation). Used may mean that the battery assembly has been utilized at least once (e.g., at least once charge and discharge cycle). Reused may mean that one or more components of the battery assembly have previously been part of a used battery assembly, one or more components of the battery assembly have been salvaged, or both. The used battery assembly may be the same or different as the reused battery assembly. In other words, the majority or minority of the components of the reused battery assembly may be from the same used battery assembly, but after salvaging. For example, a reused battery assembly may have just one or more two electrochemical cells with salvaged components therein. As another example, almost a majority or all of the electrochemical cells of the battery assembly may utilize one or more salvaged components from the same battery from previous uses or from a plurality of other used batteries. The battery assembly may be a partial and/or a full battery pack. A battery pack may be a plurality of electrochemical cells, a plurality of battery units, or both which form the pack. The battery assembly may include one or more battery units. A plurality of battery units may be the same or different sizes, ages, chemical compositions, the like, or any combination thereof. A battery unit may be a stack of electrode plates, an electrochemical cell, or a combination thereof. The battery assembly includes one or more stacks of a plurality of electrode plates. The plurality of electrode plates may include one or more bipolar plates, monopolar plates, dual polar plates, end plates, or any combination thereof. The stack may include a separator and an electrolyte located between each adjacent pair of the electrode plates. The electrolyte may cooperate with an anode and cathode to form an electrochemical cell. The battery assembly may include one or more channels. The one or more channels may pass transversely through one or more electrode plates, electrolyte, separators, or a combination thereof. The one or more channels may be referred to as transverse channels. The one or more channels may be formed by openings, inserts, or both. The one or more openings, inserts, or both may be part of (e.g., attached, integral) the one or more electrode plates, separators, or both. The one or more channels may be sealed from a liquid electrolyte through which it passed. One or more fluids may circulate through the one or more channels. The one or more fluids may aid controlling temperature of the battery assembly during pickling, forming, charging, discharging or any combination thereof.

The battery assembly may include a plurality of electrode plates. The electrode plates may be useful as bipolar plates, monopolar plates, dual polar plates, end plates, the like or any combination thereof. An electrode plate may function as one or more electrodes, include one or more electroactive masses, be part of an electrochemical cell, form part of one or more sealing structures, or any combination thereof. A plurality of electrode plates may function to conduct an electric current (i.e., flow of ions and electrons) within the battery assembly. A plurality of electrode plates may form one or more electrochemical cells. For example, a pair of electrode plates, which may have a separator and/or electrolyte therebetween, may form an electrochemical cell. The number of electrode plates present can be chosen to provide the desired voltage of the battery. The battery assembly design provides flexibility in the voltage that can be produced. The plurality of electrode plates can have any desired cross-sectional shape and the cross-sectional shape can be designed to fit the packaging space available in the use environment. Cross-sectional shape may refer to the shape of the plates from the perspective of the faces of the substrates. Flexible cross-sectional shapes and sizes allow preparation of the assemblies disclosed to accommodate the voltage and size needs of the system in which the batteries are utilized. The one or more electrode plates may include one or more nonplanar structures such as described in PCT Application No. PCT/US2018/033435, incorporated herein by reference in its entirety.

Electrode plates may include a substrate having one or more active masses (i.e., anode, cathode) on one or both surfaces. One or more bipolar plates include a substrate having an anode on one surface and a cathode on an opposing surface. A monopolar plate may include either an anode or a cathode deposited on a surface. A monopolar plate may be free of active mass on a side opposing one with active mass. First and second monopolar plates may be located at opposing ends of the one or more stacks having the bipolar plates, dual polar plates, or both located therebetween. The battery assembly may include one or more end plates, such as a first end plate and a second plate. The one or more end plates are attached at one or more ends of the stack. The one or more end plates may be the one or more monopolar plates or separate from the monopolar plates. For example, a first end plate may be attached at an opposing end of the stack as a second end plate. The one or more end plates may be particularly useful for reinforcing one or more electrode plates during drawing of a vacuum within the battery assembly, filling of the battery assembly, during operation in a charge and/or discharge cycle of the battery assembly, or any combination thereof. One or more end plates and/or monopolar plates may have an internal reinforcement structure as disclosed in U.S. Pat. No. 10,141,598, incorporated herein by reference in its entirety. One or more electrode plates may have one or more features as disclosed in PCT Publication No: WO2018/0213730, incorporated herein by reference in its entirety.

One or more electrode plates may include one or more substrates. One or more substrates may function to provide structural support for the cathode and/or the anode; as a cell partition so as to prevent the flow of electrolyte between adjacent electrochemical cells; cooperating with other battery components to form an electrolyte-tight seal about the bipolar plate edges which may be on the outside surface of the battery; and in some embodiments to transmit electrons from one surface to the other. The substrate can be formed from a variety of materials depending on the function or the battery chemistry. The substrate may be formed from materials that are sufficiently structurally robust to provide the backbone of a desired bipolar electrode plate, withstanding temperatures that exceed the melting points of any conductive materials used in the battery construction, and having high chemical stability during contact with an electrolyte (e.g., sulfuric acid solution) so that the substrate does not degrade upon contact with an electrolyte. The substrate may be formed from suitable materials and/or is configured in a manner that permits the transmission of electricity from one surface of the substrate to an opposite substrate surface. The substrate may be formed from an electrically conductive material, e.g., a metallic material, or can be formed from an electrically non-conductive material. Exemplary non-conductive materials may include one or more polymers, such as thermoset polymers, elastomeric polymers or thermoplastic polymers or any combination thereof. The non-conductive substrate may have electrically conductive features constructed therein or thereon. Examples of polymeric materials that may be employed include polyamide, polyester, polystyrene, polyethylene (including polyethylene terephthalate, high density polyethylene and low-density polyethylene), polycarbonates (PC), polypropylene, polyvinyl chloride, bio-based plastics/biopolymers (e.g., polylactic acid), silicone, acrylonitrile butadiene styrene (ABS), or any combination thereof, such as PC/ABS (blends of polycarbonates and acrylonitrile butadiene styrenes). Composite substrates may be utilized, the composite may contain reinforcing materials, such as fibers or fillers commonly known in the art, two different polymeric materials such as a thermoset core and a thermoplastic shell or thermoplastic edge about the periphery of the thermoset polymer, or conductive material disposed in a non-conductive polymer. The substrate may comprise or have at the edge of the plates a thermoplastic material that is bondable, preferably melt bondable.

One or more electrode plates may include one or more frames. One or more frames may facilitate stacking of electrode plates, formation of electrochemical cells, sealing of electrolyte within the electrochemical cells, and the like. The one or more frames may be located at least partially or completely about a periphery of one or more substrates. The one or more frames may be separate from or integral with one or more substrates. For example, a frame may be integral with and located about a periphery of a substrate. One or more frames may be a raised edge. A raised edge may facilitate stacking. A raised edge may be a raised edge projecting from at least one of the two opposing surfaces of the electrode plate (e.g., substrate). One or more sides of the raised edge may include one or more indentations so as to nest with a frame of an adjacent electrode plate or even separator. The frame may function as a separator. A frame may be comprised of non-conductive material, such as a thermoplastic material. The use of non-conductive material may enhance sealing about the outside of the battery stack. The frame may be made of a thermoplastic material which is the same or different than that of the substrate. The frame of an electrode plate, end plate, or both may have similar characteristics as applicable for a frame of a separator. One or more suitable frames and edge seals may be disclosed in PCT Publication No. WO 2020/0243093, incorporated herein by reference in its entirety. The one or more frames may also cooperate with or be replaced with one or more cell seals.

The battery assembly may comprise one or more cell seals. The one or more cell seals may prevent electrolyte and gasses evolved during operation from leaking from the cells to the exterior of the battery, may isolate the cells from one another, or both. One or more cell seals may be located between adjacent substrates, frames, or both. For example, a cell seal may be located between adjacent frames. One or more cell seals may be located about a periphery of one or more electrochemical cells. One or more cell seals may be formed by or separate from one or more outer seals, internal seals, or both. Outer seals may include an edge seal, membrane, and/or casing. Internal seals may include one or more sealing features. One or more cell seals may be held in place via compression. Compression applied via one or more posts and overlapping portions may apply a compression force to the stack of electrode plates which retains and/or compresses the one or more cell seals. The one or more cell seals may include one or more gaskets. One or more gaskets may be rigid, elastomeric, or both. One or more cell seals may be suitable for being in contact with electrolyte. One or more gaskets may include one or more molded-in compliable features, liquid gaskets, flat gaskets, O-rings, the like, or a combination thereof. One or more cell seals may be comprised of non-metallic, semi-metallic, and/or metallic material. One or more cell seals may be comprised of one or more polymeric materials.

One or more of the electrode plates may include one or more sealing members. The one or more sealing members may function to cooperate with one or more other sealing members to provide an internal, integrated cell seal and preventing gasses and liquid electrolyte leaking from one or more electrochemical cells; aiding in alignment of one or more electrode plates with another to form a stack; or both. The one or more sealing members may be advantageous in being able to repeatedly be assembled and disassembled from one or more other sealing members while continuously providing a liquid and gas tight internal cell seal. The one or more sealing members may be beneficial as they may provide a sufficient cell seal such that the battery assembly may be free of one or more, or any, outer seals. The one or more sealing members may have any suitable size, shape, and/or configuration need to provide an internal cell seal. An internal cell seal may be defined as being located within the periphery of one or more electrode plates, frames, or both; being located between adjacent electrode frames and/or separators; or a combination thereof. The one or more sealing features may be formed as one or more tabs, fingers, teeth posts, wells, the like, or a combination thereof. The one or more sealing features may have a three-dimensional shape which is partially or substantially a trapezoidal prism, trapezium prism, rectangular prism, cylinder, pyramid, cone, tetrahedron, triangular prism, cube, sphere, the like, or a combination thereof. The one or more sealing features may have a two-dimensional shape which is partially or substantially a trapezoid, trapezium, rectangle, square, triangle, circle, rhombus, oval, the like, or a combination thereof. A two-dimensional shape may be with respect to a plane parallel to an outer peripheral surface of a frame, parallel to a longitudinal axis of a stack, or both. A three-dimensional shape and/or two-dimensional shape which is wider at the base and narrower at the end (e.g., tapering, narrowing). The base may be the portion closed to, affixed to, or integral with a frame and/or substrate. A narrowing shape may aid in aligning and nesting within one or more other sealing members. The one or more sealing members may include one or more projections, indentations, or both. The one or more indentations may be configured to receive and/or be reciprocal with one or more projections. The one or more indentations may be formed in a frame, substrate, or both of an electrode plate. The one or more projections may be affixed to and/or integral with a frame, substrate, or both of an electrode plate. Affixed may be secured via one or more adhesives and/or fasteners (e.g., threaded stud, screw), insert molded, molded, or a combination thereof. One or more indentations may be referred to as one or more female sealing members. One or more projections may be referred to as one or more male sealing members. The one or more male sealing members may extend from an inward-facing surface. An inward-facing surface may be a surface which faces toward an adjacent electrode plate, substrate, or both. Upon stacking, one or more male sealing members of an individual electrode plate may align and nest within one or more female sealing members of another individual electrode plate. With application of compression force, such as by one or more posts, the one or more male sealing members may form an interference fit (e.g., via compression) with one or more female sealing members. The one or more male sealing members may have a width slightly equal to or larger than a width of one or more female sealing members. Width may be measured parallel to an inward-facing surface of a frame and/or substrate. The interference fit may be a force fit, shrink fit, or both. An interference fit may be beneficial in providing for a mating relationship which can repeatedly providing a tight seal while allowing for easy and repeated disassembly and assembly and maintaining integrity of the sealing members. The one or more male sealing members may extend toward an adjacent electrode plate prior to stacking and/or compressing; be located within an adjacent electrode plate during and/or after stacking and/or compressing; or both. The one or male sealing members may extend at an angle relative to a substrate. The one or more male sealing members may extend at an angle which is generally acute, perpendicular, or even obtuse relative to the substrate. The one or more sealing members may be continuous, discontinuous, evenly spaced, randomly spaced, or a combination thereof about a frame, substrate, or both. The one or more sealing members may be made of a material suitable for providing a seal from a liquid electrolyte. The one or more sealing members may be substantially rigid, flexible, elastic, or a combination thereof. The one or more sealing members may be made of a material is with chemical resistant properties. The one or more sealing members may be made from a same or differing material as a substrate, frame, or both of an electrode plate. The one or more sealing members may be comprised of one or more non-conductive material, such as one or more polymers. The one or more polymers may include one or more thermoplastic polymers, elastomeric polymers, thermoset polymers, or a combination thereof. Examples of polymeric materials may include thermoplastic elastomer (TPE), thermoplastic polyurethane (TPU), silicone, polyvinyl chloride (PVC), polypropylene, thermoplastic polyolefin (TPO), the like, or a combination thereof.

One or more of the electrode plates may include one or more active masses. The one or more active masses may function as a cathode, an anode, or both of the electrode plate. The one or more active masses may be any form commonly used in batteries to function as an anode, cathode, or both. A bipolar plate may have one or more active masses on a surface functioning as a cathode and one or more active masses on an opposing surface functioning as an anode. A monopolar plate may have one or more active masses on a surface functioning as a cathode or an anode while the opposing surface is bare of both an anode and cathode. A dual polar plate may have one or more active masses on a surface functioning as a cathode or an anode, while one or more similar active masses are on the opposing surface also functioning as a cathode or an anode. The cathode of one electrode plate may be opposing the anode of another electrode plate. The cathode may be referred to as one or more positive active masses (PAM). The anode may be referred to as one or more negative active masses (NAM). The one or more active masses may include any suitable active mass which facilitates an electrochemical reaction with the electrolyte, the opposing one or more active masses, or both of the same electrochemical cell. The one or more active masses may be selected to have a reduction and/or oxidation reaction with the electrolyte.

The one or more active masses may comprise one or more materials typically used in secondary batteries, including lead acid, lithium ion, and/or nickel metal hydride batteries. The one or more active masses may comprise a composite oxide, a sulfate compound, or a phosphate compound of lithium, lead, carbon, graphite, nickel, aluminum, or a transition metal. Examples of the composite oxides include Li/Co based composite oxide, such as LiCoO₂; Li/Ni based composite oxide, such as LiNiO₂; Li/Mn based composite oxide, such as spinel LiMn₂O₄, and Li/Fe based composite materials, such as LiFeO₂. Exemplary phosphate and sulfur compounds of transition metal and lithium include LiFePO₄, V₂O₅, MnO₂, TiS₂, MoS₂, MoO₃, PbO₂, AgO, NiOOH, FeSO₄, Na₂SO₄, MgSO₄ and the like. For example, in a lead acid battery, the one or more active masses may be or include lead dioxide (PbO2), tribasic lead oxide (3PbO), tribasic lead sulfate (3PbO·3PbSO4), tetrabasic lead oxide (4PbO), tetrabasic lead sulfate (4PbO·4PbSO4), or any combination thereof. The one or more active masses may be in any form which allows the one or more active masses to function as a cathode, anode, or both of an electrochemical cell. Exemplary forms include formed parts, in paste form, pre-fabricated sheet or film, sponge, or any combination thereof. For example, one or more active masses may include a sponge lead. Sponge lead may be useful due to its porosity. One or more suitable active masses and/or forms thereof may be described in PCT Publication Nos. WO 2018/0213730 and WO 2020/0102677, incorporated herein by reference in their entirety for all purposes.

The battery assembly may include one or more electrochemical cells. An electrochemical cell may be formed by a pair of opposing electrode plates with an opposing anode and cathode pair therebetween. One or more electrochemical cells may be sealed. The space of an electrochemical cell (i.e., between an opposing anode and cathode pair) may contain an electrolyte. The electrochemical cells may be sealed through one or more seals formed about one or more channels, one or more edges of the electrode plates, or both which may form closed electrochemical cells. The closed electrochemical cells may be sealed from the environment to prevent leakage and short circuiting of the cells.

The battery assembly may include an electrolyte. The electrolyte may allow electrons and ions to flow between the anode and cathode. The electrolyte may be located within the electrochemical cells. As the one or more electrochemical cells may be sealed, the electrolyte may be a liquid electrolyte. The electrolyte can be any liquid electrolyte that facilitates an electrochemical reaction with the anode and cathode utilized. The electrolyte may be able to pass through a separator of an electrochemical cell. The electrolytes can be water based or organic based. One or more suitable electrolytes may be sealed from leaking to an exterior of a battery assembly by one or more membranes, frames, integrated edge seals, seals, the like, or a combination thereof. Suitable forms of electrolyte are disclosed in PCT Publication Nos.: WO 2013/062623, WO 2018/213730, and WO 2020/243093, WO 2020/102677 and U.S. Pat. No. 10,141,598 incorporated herein by reference in its entirety.

The battery assembly may include one or more separators. The one or more separators may function to partition an electrochemical cell (i.e., separate a cathode an electrochemical cell from an anode of an electrochemical cell); prevent short circuiting of the cells due to dendrite formation; functions to allow liquid electrolyte, ions, electrons or any combination of these elements to pass through it; or any combination thereof. Any known battery separator which performs one or more of the recited functions may be utilized in the assemblies of the invention. One or more separators may be located between an anode and a cathode of an electrochemical cell. One or more separators may be located between a pair of adjacent electrode plates, which may include between bipolar plates or between a bipolar plate and a monopolar plate. The separators may be attached about their periphery and/or interior to one or more end plates, electrode plates, other separators, or any combination thereof. The separators may extend toward one or more frames of one or more electrode plates but may be located within the interior periphery of the one or more frames. The separators may have a cross-sectional area that is the same or greater than the area of the adjacent cathode and anode. The separator may completely separate the cathode portion of the cell from the anode portion of the cell. The edges of the separator may or may not contact peripheral edges of adjacent electrode plates. The peripheral edges may be the interior facing surfaces of the frames. A separator may alternatively include a frame, similar to the frame of the electrode plates. The frame of the separator may align and stack with adjacent frames of the electrode plates. A separator may be formed as one or more sheets. A separator may include or be separate from one or more transfer sheets. One or more transfer sheets may be used in lieu of or in conjunction with one or more separators. An exemplary transfer sheet suitable for use with or as a separator is described in PCT Publication Nos. WO 2018/0213730 and WO 2020/0102677, incorporated herein by reference in their entirety for all purposes.

The one or more sheets of a separator may be non-conductive. By being non-conductive, the separation between the active masses is facilitated. One or more non-conductive materials may be inorganic, organic, or both. Organic materials may include cotton, rubber, asbestos, wood, the like, or any combination thereof. One or more inorganic materials may include one or more polymers, glass, ceramic, the like, or any combination thereof. One or more polymers may include one or more polyesters, polyethylene, polypropylene, polyvinyl chloride, polytetrafluoroethylene, nylon, ion gels, the like, or any combination thereof. The one or more sheets may be formed by nonwoven fibers, woven fibers, films, the like, or any combination thereof. For example, the one or more sheets may be an absorbent glass mat (AGM). As another example, the sheet may be a porous, ultra-high molecular weight polyolefin membrane. The sheet may be porous. Pores may allow for the electrolyte, ions, electrons, or a combination thereof to pass through the separator. Pores may be substantially straight, tortuous, or a combination thereof through a thickness of the sheet. The sheet has a thickness. The thickness may be measured as the distance between exterior faces of the sheet. The exterior faces may be those facing toward, substantially parallel with or both, an adjacent anode, cathode, or both. The thickness may be suitable to facilitate the battery assembly's energy and power density. A suitable thickness may be chosen based on the overall size of the battery assembly. A thickness of the sheet may be about 10 μm or greater, about 25 μm or greater, about 100 μm or greater, or even about 500 μm or greater. A thickness of the sheet may be about 1 cm (10,000 μm) or less, about 0.5 cm (5,000 μm) or less, about 0.3 cm (3,000 μm) or less, or even about 0.1 cm (1,000 μm) or less. For example, a thickness of a sheet may be about 500 μm to about 0.3 cm. A thickness of the sheet may be uniform or variable across all or a portion of the sheet. A variable thickness may be due to one or more troughs formed in the separator.

One or more electrode plates, end plates, separators, or a combination thereof may include one or more openings. The one or more openings may function to provide an opening for an attachment mechanism to pass therethrough; cooperate with one or more electrode plates, separators, end plates, and/or inserts to form part of one or more channels; house or be part of one or more seals; house one or more posts, allow for vacuum pulling, filling, and/or venting of the battery assembly; provide for circulation of a fluid through one or more channels; retain one or more electrically conductive materials; or any combination thereof. The one or more openings may have any size, shape, and/or configuration to provide any combination of the desired functions. The one or more openings may have any combination of the features as described for openings and/or holes in one or more electrode plates, end plates, and/or substrates. One or more openings of one or more electrode plates, end plates, and/or separators may align (i.e., be concentric) with one or more openings of one or more other electrode plates, end plates, and/or separators so as to form one or more channels. Alignment may be in a transverse direction. Transverse may mean substantially perpendicular to a face of a substrate and/or separator, across a length of the battery assembly, parallel to a longitudinal axis of the battery assembly, or a combination thereof. The transverse direction may be substantially perpendicular the opposing surfaces of the substrates upon which a cathode and/or anode may be deposited. Transverse may mean that the general width, diameter, or both of a cross-section of the one or more openings is substantially parallel to a face of a substrate and/or separator. One or more openings of an electrode plate, end plate, and/or substrate may have a shape and/or size similar to one or more openings of another electrode plate, end plate, and/or separator which may be adjacent. The one or more openings may have a cross-sectional shape which functions to receive an attachment mechanism, receive a post, cooperate with an insert, or any combination of the desired functions of the openings and may be generally rectangular, circular, triangular, elliptical, ovular, or any combination thereof. The one or more openings may have a cross-sectional width sufficient to receive one or more attachment mechanisms, one or more posts, one or more valves, or any combination thereof. The openings may be machined (e.g., milled), formed during fabrication of the substrate (e.g., by a molding or shaping operation), or otherwise fabricated. The openings may have straight and/or smooth internal walls or surfaces. The size and frequency of the openings formed in the substrate may affect the resistivity of the battery. One or more openings may have a cross-sectional width less than, equal to, or greater than a diameter of one or more openings formed within the same end plate and/or an adjacent electrode plate. A cross-sectional width of one or more openings may be continuous, taper, or expand along a length of an opening. A cross-sectional width of one or more openings may be suitable for receive one or more posts, rods, fluids, electrolyte, or a combination thereof therethrough. The one or more openings may have a cross-sectional width of about 0.2 mm or more, 1 mm or more, about 3 mm or more, or even about 5 mm or more. The one or more openings may have a cross-sectional width of about 30 mm or less, about 25 mm or less, or even about 20 mm or less. A cross-sectional width of an opening may be considered the same as a diameter of an opening. The one or more openings may pass partially or completely through an insert, a base, a substrate, a separator, a reinforcement structure, a rib structure, or any combination thereof. The one or more openings may be located about or adjacent a periphery, within an interior, or both of an end plate, electrode plate, separator, or combination thereof. The one or more openings may be distributed about a periphery, within an interior defined within the periphery, or both of an end plate, electrode plate, separator, or a combination thereof. The one or more openings may be located adjacent to one or more rib structures, between two or more rib structures, within a cell, adjacent one or more inserts, within one or more inserts, or any combination thereof. The one or more openings may form a repetitive pattern, may be aligned with one or more other openings, may be staggered or offset from one or more other openings, or any combination thereof. One or more openings of an electrode plate, end plate, and/or substrate may have a larger diameter than one or more other openings of the same electrode plate, end plate, and/or substrate. An opening may be about at least about 1.5 times, at least about 2 times, or even at least about 2.5 times larger than another opening. An opening may be about 4 times or less, about 3.5 times or less, or even about 3 times or less larger than another opening. The openings may be formed having a density of at least about 0.02 openings per cm². The openings may be formed having a density of less than about 4 openings per cm². The openings may be formed having a density from about 2.0 openings per cm² to about 2.8 openings per cm². The one or more openings may include one or more peripheral openings, one or more internal openings, one or more channel openings, one or more conductive openings, the like, or any combination thereof.

One or more openings may include one or more channel openings. The one or more channel openings may function to align with one or more openings of one or more electrode plates to form one or more channels; provide an opening for venting, filling, and/or venting the battery assembly; providing an opening for circulating one or more fluids within an interior of the battery assembly; cooperate with one or more valves, receive one or more posts to compress the stack of electrode plates; receive one or more channel seals; or any combination thereof. The one or more channel openings may align (i.e., concentric alignment) with one or more openings and/or holes of one or more electrode plates, end plates, and/or separators in a transverse direction to form one or more channels through the stack. The one or more channel openings may have a size substantially equal to one or more holes of one or more other electrode plates, end plates, and/or separators. The one or more channel openings may have any size through which one or more posts, rods, fluids, or a combination may pass through. One or more channel openings may have a smaller, equal, or larger cross-sectional width or area than one or more other channel openings. For example, one channel opening may have a larger diameter than one or more other channel openings to allow for filling, venting, cooling, and/or heating of the battery. One or more channel openings may be connected to or in communication with one or more valves. For example, a channel opening having a larger diameter than other channel openings may be connected to a valve. A surface of the base near and/or adjacent to one or more channel openings may be a sealing surface.

One or more openings may include one or more conductive openings. One or more conductive openings may be filled with an electrically conductive material, e.g., a metallic-containing material. The one or more conductive openings may be formed in one or more electrode plates, end plates, substrates, or a combination thereof. The electrically conductive material may be a material that undergoes a phase transformation at a temperature that is below the thermal degradation temperature of the substrate so that at an operating temperature of the battery assembly that is below the phase transformation temperature, the dielectric substrate has an electrically conductive path via the material admixture between the first surface and the second surface of the substrate. Further, at a temperature that is above the phase transformation temperature, the electrically conductive material admixture undergoes a phase transformation that disables electrical conductivity via the electrically conductive path. For instance, the electrically conductive material may be or include a solder material, e.g., one comprising at least one or a mixture of any two or more of lead, tin, nickel, zinc, lithium, antimony, copper, bismuth, indium or silver. The electrically conductive material may be substantially free of any lead (i.e., it contains at most trace amounts of lead) or it may include lead in a functionally operative amount. The material may include a mixture of lead and tin. For example, it may include a major portion tin and a minor portion of lead (e.g., about 55 to about 65 parts by weight tin and about 35 to about 45 parts by weight lead). The material may exhibit a melting temperature that is below about 240° C., below about 230° C., below about 220° C., below 210° C. or even below about 200° C. (e.g., in the range of about 180 to about 190° C.). The material may include a eutectic mixture. A feature of using solder as the electrically conductive material for filling the openings is that the solder has a defined melting temperature that can be tailored, depending on the type of solder used, to melt at a temperature that may be unsafe for continued battery operation. Once the solder melts, the substrate opening containing the melted solder is no longer electrically conductive and an open circuit results within the electrode plate. An open circuit may operate to dramatically increase the resistance within the bipolar battery thereby stopping further electrical flow and shutting down unsafe reactions within the battery. Accordingly, the type of electrically conductive material selected to fill the openings can vary depending on whether it is desired to include such an internal shut down mechanism within the battery, and if so at what temperature it is desired to effect such an internal shutdown. The substrate will be configured so that in the event of operating conditions that exceed a predetermined condition, the substrate will function to disable operation of the battery by disrupting electrical conductivity through the substrate. For example, the electrically conductive material filling holes in a dielectric substrate will undergo a phase transformation (e.g., it will melt) so that electrical conductivity across the substrate is disrupted. The extent of the disruption may be to partially or even entirely render the function of conducting electricity through the substrate disabled. One or more conductive openings may be smaller than or equal in size (e.g., in diameter) to one or more other openings of an end plate, electrode plate, substrate, or a combination thereof. One or more conductive openings may have a diameter that is about 1% or greater, 5% or greater, 10% or greater, or even about 25% or greater as compared to a diameter of one or more other openings (e.g., channel openings, peripheral openings, internal openings). One or more conductive openings may have a diameter about 75% or less, about 50% or less, or even about 40% or less as compared to a diameter of one or more other openings.

One or more electrode plates, end plates, separators, or any combination thereof may include one or more inserts. The one or more inserts may function to interlock with one or more inserts of another electrode plate, end plate, separator, or a combination thereof; to define a portion of one or more channels passing through the stack; forming a leak proof seal along one or more channels; cooperate with one or more valves; providing a housing for one or more rods and/or posts; allow for a fluid to pass therethrough; or any combination thereof. The one or more inserts may have any size and/or shape to interlock with one or more inserts of an electrode plate, end plate, and/or separator, form a portion of a channel; form a leak proof seal along one or more channels; cooperate with one or more valves; or any combination thereof. The one or more inserts may be integral with or attached to an electrode plate, end plate, separator, or a combination thereof. The one or more inserts may be integral with or attached to a substrate, base, or both. The one or more inserts may be formed as one or more bosses. An insert which is integral with a surface of an end plate (e.g., base), electrode plate (e.g., substrate), and/or separator and projects from that surface may be defined as a boss. The one or more inserts may be integrally formed through compressive forming, tensile forming, molding, or the like, or any combination thereof. Compressive forming may include die forming, extrusion, indenting, the like, or any combination thereof. Molding may include injection molding. Where an electrode plate, end plate, and/or separator has both inserts and a frame, raised edges, and/or a recessed portion, these parts may be molded in one step, for instance by injection molding. One or more inserts may project from a surface of an end plate, electrode plate, and/or separator thus forming one or more raised inserts. One or more inserts may project from a base of an end plate, substrate of an electrode plate, a surface of a separator, or any combination thereof. One or more inserts may project in a same or opposing direction as one or more rib structures from a base, substrate, or both. One or more inserts may have the same height and/or thickness as one or more rib structures, one or more other inserts, or both. One or more inserts may project substantially orthogonally or oblique from a surface of the base, substrate, separator, or a combination thereof. The one or more inserts may have one or more openings therethrough. The one or more inserts may have one or more peripheral openings, internal openings, channel openings, or a combination thereof therethrough. The one or more inserts may be concentric and formed about one or more openings. One or more inserts may extend a length of an opening (e.g., an opening may pass entirely through an insert). A sealing surface may be formed between the outer diameter of one or more openings and an interior of one or more inserts. For example, a surface of the base and/or substrate substantially perpendicular to a longitudinal axis of the battery located between an insert and an opening may be a sealing surface. One or more inserts may be capable of interlocking with one or more inserts of an adjacent electrode plate, separator, and/or end plate to form a leak proof seal about a channel. For example, one or more end plates and/or electrode plates may be machined or formed to contain matching indents, on a surface opposite from an insert, for inserts, sleeves, or bushings of an adjacent electrode plate and/or separator. The inserts may contain one or more vent holes. Inserts in one or more separators may contain one or more vent holes. The vent holes may allow communication between one or more electrochemical cells and one or more channels. One or more vent holes may allow transmission of gasses from one or more electrochemical cells to one or more channels and prevent the transmission of one or more liquids (i.e., an electrolyte) from one or more electrochemical cells to one or more channels.

The battery assembly may include one or more channels. The one or more channels may function as one or more venting, filling, cooling, and/or heating channels; house one or more posts; distribute one or more posts throughout an interior of the battery assembly; prevent liquid electrolyte from coming into contact with one or more posts or other components; allow for circulation of one or more fluid within an interior of the battery assembly; or any combination thereof. The one or more channels may be formed by one or more openings of one or more end plates, electrode plates, and/or separators which are aligned. The one or more channels may be formed by one or more channel openings of one or more end plates, electrode plates, and/or separators aligned with one or more channels openings of other (e.g., adjacent) end plates, electrode plates, and/or separators. The one or more channels may be referred to as one or more integrated channels, transverse channels, or both. The one or more channels may pass through one or more electrochemical cells, may be located at least partially about a periphery of one or more electrochemical cells, may be located at outer corners of the battery assembly, or any combination thereof. By passing through one or more electrochemical cells, the one or more channels may also pass through a liquid electrolyte, one or more active masses, or both. By being located about a periphery and/or corners, one or more channels may be located about and/or not extend through a liquid electrolyte, one or more active masses, or both. The channels may be sealed to prevent electrolytes and gasses evolved during operation from entering the channels. Any method of sealing which achieves this objective may be utilized. One or more seals, such as inserts, of the one or more end plates, electrode plates, and separators may interlock and surround one or more channels to prevent the liquid electrolyte from leaking into one or more channels. The one or more channels may pass through the battery assembly in a transverse direction to form one or more transverse channels. The size and shape of the channels can be any size or shape which allows them to house one or more posts. The cross-sectional shape of the channels may be round, elliptical or polygonal, such as square, rectangular, hexagonal and the like. The cross-sectional shape may be determined by the cross-sectional shape of the one or more openings and/or inserts. The size of the channels housing one or more posts is chosen to accommodate the posts used. The diameter of the channel may be equal to the diameter of the openings which align to form one or more channels. The one or more channels may comprise a series of openings in the components. A series of openings may be arranged so a post can be placed in the channel formed; so a fluid can be transmitted through the channel for cooling and/or heating; for venting; for filling with a liquid electrolyte; or any combination thereof. One or more channels having one or more fluids passed therethrough may be referred to as one or more cooling channels. The number of channels is chosen to support the end plate and edges of the end plates, electrode plates, and substrates to prevent leakage of electrolytes and gasses evolved during operation and to prevent the compressive forces arising during operation from damaging components and the seal for the individual electrochemical cells. A plurality of channels may be present so as to spread out the compressive forces generated during operation. The number and design of channels is sufficient to minimize edge-stress forces that exceed the fatigue strength of the seals. The locations of a plurality of channels are chosen so as to spread out the compressive forces generated during operation. The channels may be spread out evenly through the stack to better handle the stresses. The plurality of channels may have a cross-sectional size of about 2 mm or greater, about 4 mm or greater or about 6 mm or greater. The upper limit on the cross-sectional size of the channels is determined by practicality, if the size is too large the efficiency of the assemblies is reduced. The channels may have a cross-sectional size of about 30 mm or less, about 25 mm or less, or even about 20 mm or less.

The battery assembly may comprise one or more channel seals. The one or more channel seals may prevent electrolyte and gasses evolved during operation from leaking from the cells into the channels, one or more fluids circulating through one or more channels leaking into the one or more cells, or both. One or more channel seals may be located in a channel, about an exterior of a channel, about a post; or a combination thereof. The channel seal can be one or more membranes, sleeves, gaskets, bushings and/or a series of matched inserts in the end plates, electrode plates, and/or separators, inserted in the channel, and/or residing w/in an opening. One or more gaskets may include molded in compliable features, liquid gaskets suitable for curing, flat gaskets, o-rings, and the like. The channel can be formed by a series of sleeves, gaskets, bushings, inserts, or a combination thereof which are inserted or integrated into the end plates, electrode plates, and/or separators. One or more channel seals may be compressible or capable of interlocking with one another to form a leak proof seal along the channel. The channel seal can be prepared from any material that can withstand exposure to the electrolyte, circulating fluids, operating conditions of the electrochemical cells, forces exerted by inserting a post or by the post in the channel, or a combination thereof. The one or more channel seals may be comprised of one or more polymeric materials. The one or more polymeric materials may be substantially rigid, elastomeric, or a combination of both. For example, one or more sleeves and/or inserts may be relatively rigid. For example, one or more gaskets, bushings, and/or membranes may be substantially elastomeric. The one or more channel seals may have a different color than one or more substrates, sheets, active masses, or any combination thereof. A different color may allow for the one or more channel seals to be visually distinguished from a substrate, sheet, and/or active mass.

The battery assembly may include one or more posts. The one or more posts may function to hold the stack of components together in a fashion such that damage to components or breaking of the seal between the edges of the components of the stack is prevented, ensure uniform compression across the separator material, and ensure uniform thickness of the separator material. The one or more posts may or may not be reusable. One or more reusable posts may be able to be removed during disassembly then reused without significant reprocessing. The one or more posts may have on each end an overlapping portion which engages the outside surface of opposing end plates, such as a sealing surface of each end plate. The overlapping portion may function to apply pressure on outside surfaces of opposing end plates in a manner so as to prevent damage to components or breaking of the seal between the edges of the components of the stack, and prevent bulging or other displacements of the stack during battery operation. The overlapping portion may be in contact with a sealing surface of an end plate. The stack may have a separate structural or protective end-piece over the monopolar endplate and the overlapping portion will be in contact in with the outside surface of the structural or protective end-piece. The overlapping portion can be any structure that in conjunction with the post prevents damage to components or breaking of the seal between the edges of the components of the stack. Exemplary overlapping portions include bolt heads, nuts, molded heads, brads, cotter pins, shaft collars and the like. The posts are of a length to pass through the entire stack and such length varies based on the desired capacity of the battery. The posts may exhibit a cross-section shape and size so as to fill a channel. The posts may have a cross-sectional size greater than the cross-sectional size of one or more channels. The posts may form an interference fit with one or more of the channels. The one or more posts may be located within one or more channels which do and/or do not extend through liquid electrolyte, active masses, and/or any active region of one or more electrochemical cells. The number of posts is chosen to support the end plate and edges of the substrates to prevent leakage of electrolytes and gasses evolved during operation and to prevent the compressive forces arising during operation from damaging components and the seal for the individual electrochemical cells, and to minimize edge-stress forces that exceed the fatigue strength of the seals. The plurality of posts may be present so as to spread out the compressive forces generated during operation. There may be fewer posts than channels where one or more of the channels are utilized as cooling channels, heating channels, venting channels, filling channels, or a combination thereof. For example, there may be four channels with three channels having a post located therein and one channel may be used as a cooling, heating vent, and/or fill channel. The posts can comprise molded posts, threaded posts, ratcheting features, or posts with one or more end attachments. The one or more posts may include end pins, c-clips, star pins, toggle pins, bolts, studs, the like, or any combination thereof. The posts may be bonded to parts of the stacks, for example the substrates, inserts in the channels, and the like. The bonds can be formed from adhesives or fusion of the polymeric materials, such as thermoplastic materials. Where the parts are threaded, the structural parts of the stack are threaded to receive the threaded posts. Posts can have a head on one end and a nut, hole for a brad or cotter pin on the other or may have a nut, hole for a brad or cotter pin on both ends. This is generally the case for non-molded posts. The posts may be constructed in such a way as to be a one-way ratcheting device that allows shortening, but not lengthening. Such a post would be put in place, then as the stack is compressed, the post is shortened so that it maintains the pressure on the stack. The post in this embodiment may have ridges that facilitate the ratcheting so as to allow the posts to function as one part of a zip tie like structure. Matching nuts and/or washers may be used with posts so as to compress the plates they are adjacent to when in place. The nuts and/or washers go one way over the posts and ridges may be present to prevent the nuts and/or washers from moving the other direction along the posts. In use the holes in the posts will have the appropriate brads, cotter pins and the like to perform the recited function. If the post is molded it can be molded separately or in place. If molded in place, in situ, a seal needs to be present in the channel to hold the molten plastic in place. A nonconductive post which is threaded may be used and can provide the necessary seal. Alternatively, a pre-molded nonconductive polymeric post may be designed to form an interference fit in the channel in a manner so as seal the channels. The posts may be formed in place by molding, such as by injection molding. The one or more posts may have a different color than one or more substrates, sheets, active masses, channel seals, or any combination thereof. A different color may allow for the one or more posts to be visually distinguished from a substrate, sheet, active mass, channel seal, or any combination thereof.

The battery assembly may include one or more valves. The one or more valves may function to draw a vacuum from an interior of the battery assembly, fill the battery assembly with an electrolyte, fill or evacuate a fluid from one or more channels, and/or vent the battery assembly during operation. The one or more valves may include a pressure release valve, check valve, fill valve, pop valve, and the like, or any combination thereof. The assembly may contain pressure release valves for one or more of the cells to release pressure if the cell reaches a dangerous internal pressure. The pressure release valves are designed to prevent catastrophic failure in a manner which damages the system the battery is used with. Once a pressure release valve is released the battery is no longer functional. The assemblies disclosed may contain a single check valve which releases pressure from the entire assembly when or before a dangerous pressure is reached. The one or more valves may be connected to and/or in communication with one or more channels formed by one or more openings of an end plate, electrode plate, separator, or any combination thereof. The one or more valves may be in communication with a channel, such as a channel having a tubular member there through or free of a tubular member. The battery assembly may include one or more valves as described in US 2014/0349147, incorporated herein by reference.

The battery assembly may include one or more terminals. The one or more terminals may function to transmit the electrons generated in the electrochemical cells to a system that utilizes the generated electrons in the form of electricity, such as an external load. The one or more terminals may pass through one or more end plates, one or more electrode plates, a membrane, and/or a case. The one or more terminals may pass through an electrode plate from an end plate to the outside or passing through the side of the case or membrane about the assembly essentially parallel to the plane of the end plates. The terminal matches the polarity of the anode or cathode of the monopolar plate. The cathode of the monopolar plate and the cathodes of one or more of the bipolar plates with a cathode current collector may be connected to independent positive terminals. The anode of the monopolar plate and the anodes of one or more of the bipolar plates with an anode current collector may be connected to independent negative terminals. The cathode current collectors may be connected, and the anode current collectors may be connected in parallel. The individual terminals may be covered in a membrane leaving only a single connected positive and a single connected negative terminal exposed.

The battery assembly may include an outer seal. The outer seal may function to seal about an exterior of one or more electrochemical cells, protect exterior edges of one or more electrode plates, isolate one or more electrochemical cells and the liquid electrolyte contained therein, or any combination thereof. An outer seal may include an edge seal, membrane, case, the like, or any combination thereof. One or more edge seals may include one or more integrated edge seals. The integrated edge seals may be integral with the one or more electrode plates. One or more suitable edge seals may be disclosed in PCT Publication No. WO 2020/0243093, incorporated herein by reference in its entirety.

The battery assembly may include a membrane. The membrane may be bonded to the edges of the one or more end plates, plurality of electrode plates, and/or one or more separators by any means that seals the edges of the end plates, electrode plates, and separators and isolates the one or more electrochemical cells. Exemplary bonding methods comprise adhesive bonding, melt bonding, vibration welding, RF welding, and microwave welding among others. The membrane may be a sheet of a polymeric material which material can seal the edges of the end plates, monopolar plates, and bipolar plates and can withstand exposure to the electrolyte and the conditions the battery is exposed to internally and externally. The same materials useful for the substrate of the electrode plates may be utilized for the membrane. The membrane may be a thermoplastic polymer that can be melt bonded, vibration welded or molded about the substrates of the monopolar and bipolar plates. The same thermoplastic polymer may be utilized for the monopolar and bipolar substrates and the membranes. Exemplary materials are polyethylene, polypropylene, ABS and, polyester, with ABS most preferred. The membranes may be the size of the side of the stacks to which they are bonded, and the membranes are bonded to each side of the stack. The edges of the adjacent membranes may be sealed. The edges can be sealed using adhesives, melt bonding or a molding process. The membranes may comprise a single unitary sheet which is wrapped about the entire periphery of the stack. The leading edge of the membrane, first edge contacted with the stack, and the trailing edge of the stack, end of the membrane sheet applied, are may be bonded to one another to complete the seal. This may be performed by use of an adhesive, by melt bonding or a molding process. In melt bonding the surface of the membrane and/or the edge of the stack are exposed to conditions at which the surface of one or both becomes molten and then the membrane and the edge of the stack are contacted while the surfaces are molten. The membrane and edge of the stack bond as the surface freezes forming a bond capable of sealing the components together. The membrane may be taken from a continuous sheet of the membrane material and cut to the desired length. The width of the membrane may match the height of the stacks of monopolar and bipolar plates. The membrane has sufficient thickness to seal the edges of the stack of monopolar and bipolar sheets to isolate the cells. The membrane may also function as a protective case surrounding the edges of the stack. The membrane may have a thickness of about 1 mm or greater, about 1.6 mm or greater or about 2 mm or greater. The membrane may have a thickness of about 5 mm or less, 4 mm or less or about 2.5 mm or less. When the membrane is bonded to the edge of the stack, any adhesive which can withstand exposure to the electrolyte and the conditions of operation of the cell may be used. Exemplary adhesives are plastic cements, epoxies, cyanoacrylate glues or acrylate resins. Alternatively, the membrane may be formed by molding a thermoplastic or thermoset material about a portion of, or all of, the stack of electrode plates. Any known molding method may be used including thermoforming, reaction injection molding, injection molding, roto molding, blow molding, compression molding and the like. The membrane may be formed by injection molding the membrane about a portion of or all of the stack of electrode plates. Where the membrane is formed about a portion of the stack of the plates it may be formed about the edges of the electrode plates or electrode plates and the separator.

An outer seal may include a case. The case may be the membrane or separate from a membrane. Alternatively, the membrane in conjunction with a protective covering over the monopolar plates at the end of the stack may be used as a case for the battery. As another alternative or in conjunction with, one or more frames of one or more electrode plates and/or separators bonded (e.g., melt-bonded) together about a peripheral surface may form the case. The monopolar plates may have an appropriate protective cover attached or bonded to the surface opposite the anode or cathode. The cover may be the same material as the membrane or a material that can be adhesively bonded or melt bonded to the membrane and can have a thickness within the range recited for the membranes. If affixed to the end of the plates the cover can be affixed with any mechanical attachment including the posts having overlapping portions. The case may be formed by molding a membrane about the stacks of electrode plates and/or the opposite sides of the monopolar plates.

### Illustrative Embodiments

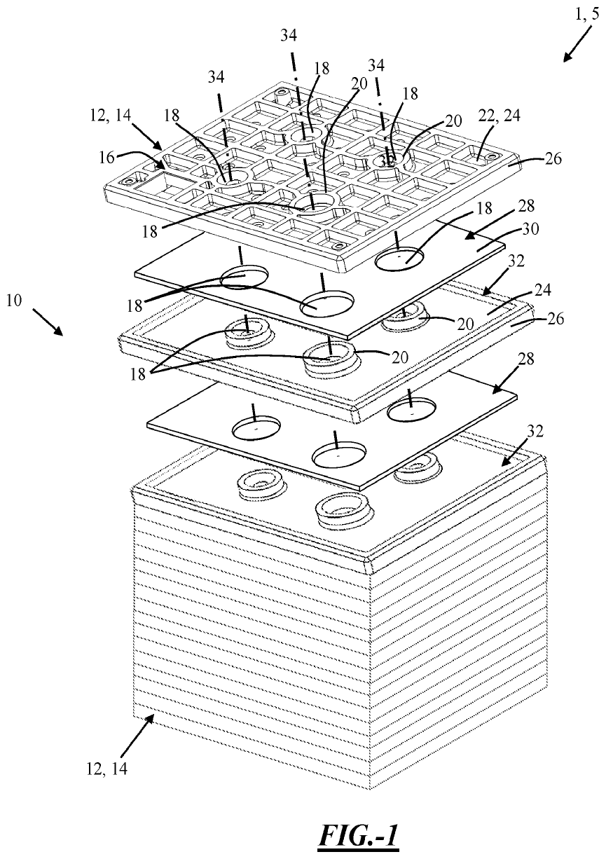

FIG. 1 shows a partially exploded stack 5 of electrode plates 10 which form a battery assembly 1. The battery assembly 1 may be recognized as a bipolar battery assembly. Shown are opposing end plates 12 (e.g., first and second end plates). The end plates 12 are also monopolar plates 14. The end plate 12 includes an internal reinforcement structure 16. The end plate 12 includes a plurality of channel openings 18. Each channel opening 18 is partially surrounded by an insert 20. The insert 20 projects from a base 22 of the end plate 12. The base 22 is also the substrate 24 of the monopolar plate 14. Located about the substrate 24 is a frame 26. Adjacent to the monopolar plate 14 is a separator 28. The separator 28 is in the form of a sheet 30. The separator 28 further includes a plurality of channel openings 18. The channel openings 18 of the separator 28 allow for the inserts 20 of the electrode plates 10 to pass therethrough. Adjacent to the separator 28 is a bipolar plate 32. The bipolar plate 32 includes a substrate 24. The substrate 24 of the bipolar plate 32 includes a frame 26 about its periphery. The frame 26 forms a raised edge about the periphery of the substrate 24. The bipolar plate 32 includes a plurality of channel openings 18. Each channel opening 18 is partially surrounded by an insert 20. The insert 20 projects from the substrate 24 of the bipolar plate 32. The inserts 20 of the monopolar plates 14 and bipolar plates 32 and the channel openings 18 of the monopolar plates 14, bipolar plates 32, and separators 28 align and interlock to form one or more channels 34 through the stack 5 of electrode plates 10.

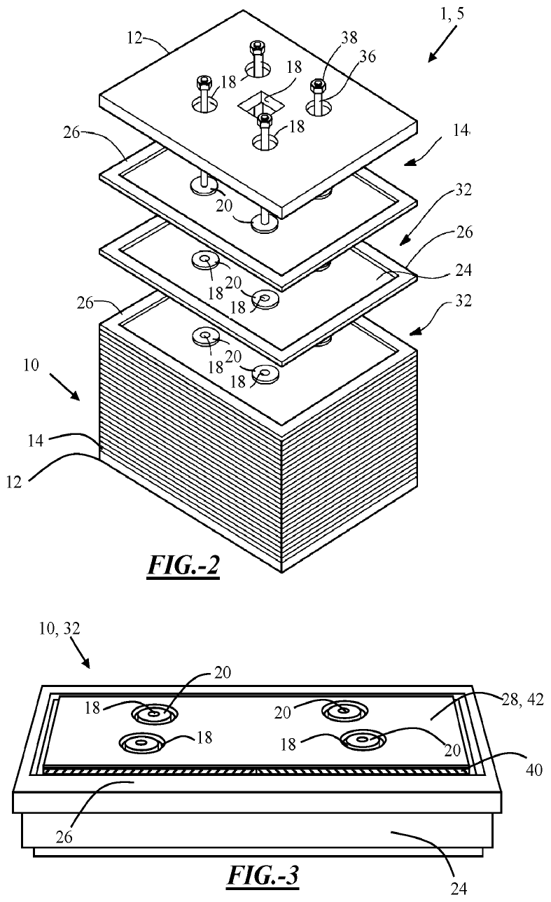

FIG. 2 shows a partially exploded stack 5 of electrode plates 10 which form a battery assembly. Shown are opposing end plates 12 (e.g., fist and second end plates). The end plates 12 are adjacent to monopolar plates 14. Located between the monopolar plates 14 is a plurality of bipolar plates 32. The monopolar plates 14 and bipolar plates 32 each include a substrate 24 and frame 26. The end plates 12, monopolar plates 14, and bipolar plates 32 include channel openings 18 which align to form channels 34. The channel openings 18 of the monopolar plates 14 and bipolar plates 32 include inserts 20. The inserts 20 align and interlock to form a seal about the channels 34. Posts 36 are located through the channels 34. The posts 36 may be secured in place by one or more heads 38 (e.g., overlapping portion). The posts 36 and heads 38 apply compression to the stack 5. Separators 28 (not shown) may be located between adjacent electrode plates 10.

FIG. 3 illustrates an electrode plate 10, such as a bipolar plate 32. The bipolar plate 32 includes a substrate 24. The substrate 24 includes a frame 26 about its periphery. The frame 26 may be integral with the substrate 24. Located on the substrate 24 is one or more active masses 40. Located adjacent to the substrate 24 may be a separator 28. The separator 28 may be in the form of a transfer sheet 42. The active mass 40 and separator 28 include channel openings 18. One or more inserts 20 projecting from the substrate 24 extend through the channel openings 18 of the active mass 40 and separator 28. The inserts 20 are formed about channel openings 18 of the substrate 24.

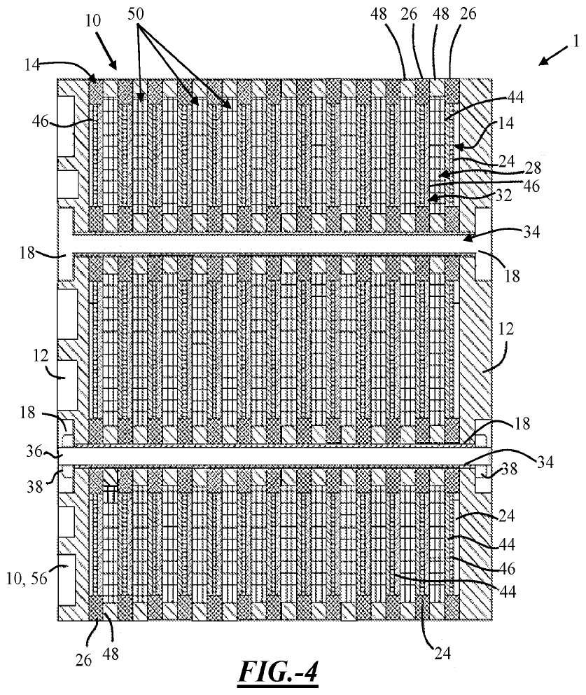

FIG. 4 a cross-section of a battery assembly 1 through the channels 34 formed by the channel openings 18 which are aligned. The channels 34 pass through the stack of electrode plates 10. Shown is a monopolar plate 14 having a substrate 24 with a cathode 44 disposed thereon. The monopolar plate 14 includes a frame 26 about the substrate 24. Adjacent to the cathode 44 of the monopolar plate 14 is a separator 28. Adjacent to separator 28 is a bipolar plate 32. The bipolar plate 32 includes a substrate 24 with an anode 46 and cathode 44 disposed thereon. The bipolar plate 32 includes a frame 26 about the periphery of the substrate 24. The frame 26 includes a raised edge 48 which projects to form a seal about the cell and mate with and adjacent frame 26. In this view, there are number of bipolar plates 32 alternatingly stacked with separators 28. At the opposite end of the stack is another monopolar plate 14 having a substrate 24 with an anode 46 disposed thereon. The stack of electrode plates 10 forms electrochemical cells 50 with the separators 28 located in the cells 50. The channels 30 pass transversely through the electrochemical cells 50. A post 36 is disposed within a channel 30. The post 36 includes an overlapping portion 38 formed at each end which seals the channel 30. Other posts 36 may be located within other channels 30.

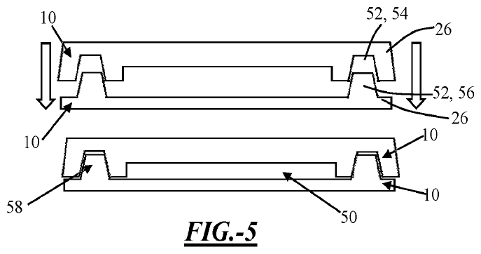

FIG. 5 illustrates stacking of two electrode plates 10. Each electrode plate 10 includes sealing members 52. The sealing members 52 are formed in the frame 26 of each electrode plate 10. The sealing members 52 of one electrode plate 10 are female sealing members 54. The female sealing members 54 are formed as indentations in the frame 26. The sealing members 52 of the adjacent electrode plate 10 are male sealing members 56. The male sealing members 56 are formed as projections extending from the frame 26. The sealing members 50 are trapezoid-shaped. The male sealing members 56 align with the female sealing members 54. The male sealing members 56 nest within the female sealing members 54. With additional force, such as via compression via posts (not shown), the male sealing members 56 form an interference-fit with the female sealing members 54. The sealing members 52 cooperating together, form an integrated, internal cell seal 58 about the electrochemical cell 50.

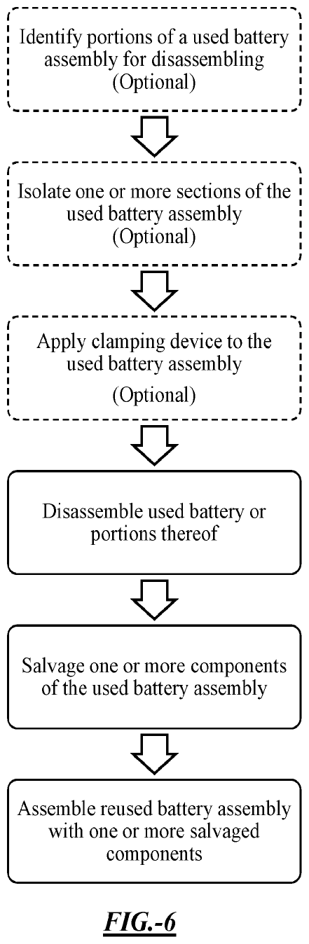

FIG. 6 illustrates a method of preparing a battery assembly 1 (not shown) which is a reused battery assembly. The method may include identifying one or more portions of a used battery assembly for disassembly. The method may include isolating one or more sections of a used battery assembly. The sections may be those identified or not identified via the identification step. The sections may or may not be one or more weak sections. The method may include applying a clamping device to one or more sections of the used battery assembly. The method includes disassembling one or more portions or the entirety of the used battery assembly. The method includes salvaging one or more components of the used battery assembly. The method includes assembling a reused battery assembly with one or more of the salvaged components from one or more used battery assemblies.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

1. A method for preparing a reused battery assembly comprising:
a) disassembling a used battery assembly;
b) salvaging one or more used components from the used battery assembly to provide for one or more reused components, wherein the salvaging includes:
(i) reprocessing one or more spent active masses to provide for one or more active masses; and
(ii) removing, cleaning, repairing, or a combination thereof one or more conductive components of one or more electrode plates;
c) assembling the reused battery assembly with the one or more reused components; and
wherein the used battery assembly and the reused battery assembly are both a bipolar battery assembly.

2-3. (canceled)

4. The method of claim 1, wherein the method includes identifying portions of the used battery assembly for disassembling.

5. The method of claim 4, wherein the method includes testing the used battery assembly; and
wherein the testing identifies one or more weak sections of the used battery assembly.

6-9. (canceled)

10. The method of a claim 5, wherein the method includes isolating the one or more weak sections of the used battery assembly and disassembling the one or more weak sections.

11-12. (canceled)

13. The method of claim 10, wherein only the one or more weak sections are disassembled while a remainder of the used battery assembly remains intact.

14. The method of claim 10, wherein the one or more weak sections are rebuilt as part of the assembling.

15-16. (canceled)

17. The method of claim 1, wherein the disassembling includes removing an electrolyte, removing one or more outer seals, removing one or more posts, separating one or more used electrode plates, breaking down one or more of the used electrode plates, removing one or more separators, removing one or more cell seals, removing one or more channel seals, removing spent active mass, or a combination thereof; and
wherein the assembling of the reused battery assembly includes forming one or more reused electrode plates, forming an electrode plate stack, applying an outer seal, incorporating an electrolyte, charging the reused assembly, or a combination thereof.

18-19. (canceled)

20. The method of claim 1, wherein during the disassembling a liquid electrolyte is drained from the used battery assembly via one or more valves of the used battery assembly, and
wherein after draining the liquid electrolyte, the disassembling includes removing one or more posts from one or more channels which removes a compressive force holding a stack of electrode plates together, and wherein the one or more channels extend through spent active mass of the used battery assembly.

21. The method of claim 1, wherein one or more outer seals of the used battery assembly are removed via force, cutting, applying heat, applying one or more solvents, applying vibration, or a combination thereof;
wherein the one or more outer seals have a different color as an exterior surface of one or more electrode plates of the used battery assembly; and
wherein upon removal of the one or more outer seals a color of the exterior surface of the electrode plates is exposed.

22-29. (canceled)

30. The method of claim 1, wherein one or more posts are a different color than one or more substrates, separators, active mass, or a combination thereof; and
wherein upon removal of the one or more posts from one or more channels of the used battery assembly, an interior color of the one or more channels is exposed.

31-32. (canceled)

33. The method of claim 1, wherein during the disassembling, the salvaging, the assembling, or a combination thereof the used battery assembly, the reused battery assembly, or both is held together by an external clamping device.

34-35. (canceled)

36. The method of claim 1, wherein reprocessing the one or more spent active masses includes removing the one or more spent active mass from one or more electrode plates; reconstituting the one or more spent active masses into one or more active masses in paste form, and pasting the one or more active masses onto a same or other one or more electrode plates.

37. (canceled)

38. The method of claim 36, wherein the one or more electrode plates are electroformed to a positive active mass and/or a negative active mass as part of the salvaging.

39. (canceled)

40. The method of a claim 1, wherein the one or more spent active masses of the used battery assembly, one or more salvaged active masses of the reused battery assembly, or both are lead-based, lithium-based, graphite-based, aluminum-based, nickel-based, or any combination thereof.

41-42. (canceled)

43. The method of claim 1, wherein the one or more spent active masses undergo one or more hydrometallurgical processes, pyrometallurgical processes, electrowinning, or a combination thereof.

44. The method of claim 1, wherein the one or more spent active masses undergoes leaching, desulfurization, calcification, thermal degradation, electrolytic processing, or a combination thereof.

45. The method of claim 1, wherein during the salvaging, the one or more spent active masses is removed from one or more substrates and/or separators by dissolution or without dissolution.

46. The method of claim 45, wherein the one or more spent active masses are removed via dissolution and a dissolution solvent includes methane sulfonic acid, acetic acid, sodium hydroxide, or any combination thereof.

47. The method of claim 45, wherein the one or more spent active masses are removed via dissolution and wherein the one or more spent active masses after dissolution are precipitated.

48-49. (canceled)

50. The method of claim 1, wherein during the salvaging, a positive active mass is reduced to lead and then formed into a lead sulfate.

51-53. (canceled)

54. The method of claim 1, wherein the one or more conductive components includes one or more current collectors, conductive materials, current conduits, terminals, or a combination thereof.

55. The method of claim 54, wherein the one or more conductive components are cleaned to have corrosion removed.

56. The method of claim 55, wherein the corrosion is removed via an aqueous solution, flushing with water, laser, sanding, other mechanical force, or any combination thereof.

57. The method of claim 54, wherein the one or more conductive components are repaired and/or removed and replaced on a substrate of the one or more electrode plates.

58. (canceled)

59. The method of claim 1, wherein the assembling the reused battery assembly includes forming one or more reused electrode plates includes assembling the one or more reused components of an electrode plate.

60. The method of claim 1, wherein the used battery assembly, the reused battery assembly, or both include one or more current collectors which include a reusable foil.

61-62. (canceled)

63. The method of claim 60, wherein a reusable foil comprises a titanium.

64-65. (canceled)

66. The method of claim 1, wherein assembling includes forming an electrode plate stack;
wherein forming the electrode plate stack includes aligning and stacking a plurality of electrode plates to form one or more electrochemical cells therebetween, wherein one or more of the electrode plates of the electrode plate stack are used electrode plates while one or more other electrode plates are reused electrode plates or all of the electrode plates are reused electrode plates;
wherein one or more frames, inserts, sealing members, or a combination thereof of one electrode plate are aligned and interlocked with one or more other frames, inserts, sealing members, or a combination there of an adjacent electrode plate; and
wherein one or more channels are formed by aligning and interlocking inserts of a plurality of electrode plates.

67-72. (canceled)

73. The method of claim 1 wherein the assembling includes compressing an electrode plate stack;
wherein the compressing includes locating and/or forming one or more posts within one or more channels; and
wherein the one or more posts include one or more reused posts, one or more reprocessed posts, or both.

74-94. (canceled)
